(19) United States
(12) Patent Application Publication
(10) Pub. No.: US 2024/0392760 A1
(43) Pub. Date: Nov. 28, 2024

(54) ELECTRODE SYSTEM AND CONTROL MECHANISM FOR ENGINES

(71) Applicant: Georgia Tech Research Corporation, Atlanta, GA (US)

(72) Inventors: Lukas Graber, Atlanta, GA (US); Patrick O'Malley, Atlanta, GA (US); Adele Payman, Atlanta, GA (US); Maryam Tousi, Atlanta, GA (US); Daqi Han, Atlanta, GA (US)

(21) Appl. No.: 18/675,115

(22) Filed: May 27, 2024

Related U.S. Application Data
(60) Provisional application No. 63/504,353, filed on May 25, 2023.

(51) Int. Cl. F03H 1/00

(52) U.S. Cl. CPC F03H 1/0006

(57) ABSTRACT

An exemplary air-breathing plasma engine and methods of operation are disclosed employing an arc plasma chamber that generates plasma, e.g., electrode-coupled, direct current plasma, via electrodes continuously fed by an electrode-feeding assembly. The plasma chamber can be implemented in any one of the stages following the compression stage and having high-pressure and high-velocity air flow, e.g., for a jet engine, turbojet engine, or rocket engine.

### CROSS-REFERENCE TO RELATED APPLICATIONS

This application claims priority to U.S. Provisional Patent Application No. 63/504,353, filed May 25, 2023, which is incorporated herein by reference in its entirety.

### BACKGROUND

Electric propulsion systems that use electricity can offset the use of hydrocarbons for air travel or cargo transportation. Electric vehicle propulsion is commonly performed using electric motors to convert electrical energy into rotational torque. For example, aerial vehicles that use electrical propulsion can use electric motors to turn propellers or ducted fans that produce thrust.

Rotating propellers or fans can produce thrust but face similar limitations relating to low gravimetric and/or volumetric power density, limited speed range, and supersonic effects.

Conventional turbojet engines may employ a compression stage with a combustion chamber to generate thrust. At the output of the combustion chamber is a turbine stage that is mechanically linked via a rotating shaft to the compression stage.

Subsonic combustion engines such as ramjet or aero thermodynamic ducts employ a combustion chamber that injects and combusts fuels to output through a De Laval nozzle to convert heat and pressure into impulse. Supersonic combustion, such as SCRAIVIJET, employs a complex combustion chamber design configured with special fuel injectors to output through a divergent nozzle that can convert heat into impulse.

There is a benefit to improving the operations of engines for aircraft.

### SUMMARY

An exemplary air-breathing plasma engine and methods of operation are disclosed employing an arc plasma chamber that generates plasma (e.g., electrode-coupled, direct current plasma) via electrodes continuously fed by an electrode-feeding assembly. The plasma chamber (also referred to as an arcing chamber) can be implemented in any one of the stages following the compression stage and having high-pressure and high-velocity air flow, e.g., for a jet engine, turbojet engine, or rocket engine. The terms “arcing chamber” and “plasma chamber” are interchangeably used herein. The plasma chamber, in some embodiments, may be employed as a heat-generating stage for the jet/rocket to generate thrust or in an afterburner section for the jet/rocket. The generated heat can be converted to an impulse, e.g., using a converging-diverging (De Laval) nozzle. The system can be configured to beneficially reuse the heat byproduct generated in the compression stage. The plasma chamber, in other embodiments, can be co-located with a combustion chamber as a hybrid chamber to augment the combustion by introducing heat into the engine or as an afterburner during flight, e.g., for a conventional turbojet or turbofan jet engine. The plasma chamber can be employed in purely electrically powered aircraft and spacecraft or a hybrid of them with a turbojet engine, a ramjet, or a supersonic combustion ramjet (SCRAMJET) engine.

Generating electric plasma from electricity per the exemplary air-breathing plasma engine can provide power density and simplicity in engine design that can allow engines to operate over a wider range of temperatures (to conventional engines without the technology) as well as provide high volumetric and gravimetric power density, both for the required power supply and the plasma chamber. The electrode-feeding assembly provides replacements for the electrodes that could be subject to electrode wear and erosion as the anode material evaporates and oxidizes during the generation of the plasma and associated electrical arc.

In an aspect, an engine is disclosed, the engine including an inlet, a compressor stage, a plasma chamber, and a nozzle stage. The inlet is configured to receive input air. The compressor stage is coupled to the inlet and configured to compress the input air and reduce the air input velocity between an entry section of the compressor stage and an exit section of the compressor stage. The plasma chamber is operatively coupled to the compressor stage to receive compressed air from the compressor stage. The plasma chamber includes a set of continuously-fed electrodes configured to generate an electric arc to convert the compressed air to an electrically conductive plasma. The nozzle stage is coupled to the plasma chamber, the nozzle stage being configured to expand the electrically conductive plasma and heated air to generate an impulse.

In some implementations, the set of continuously-fed electrodes, as anodes, includes at least one rigid graphite rod drawn from a cassette. In some implementations, the set of continuously-fed electrodes, as anodes, includes at least one carbon rod drawn from a spool of flexible carbon fiber cable. In some implementations, the set of continuously-fed electrodes is configured to be consumed during operation and converted to an exhaustible gas.

In some implementations, the engine further includes a cathode, the cathode being made of copper, graphite, or copper tungsten composite. In some implementations, the cathode is configured to produce a transverse magnetic field to force an electric arc generated in an airflow stream of the compressed air to rotate.

In some implementations, the engine further includes a magnetic confinement device adjacent to the plasma chamber and configured to generate a magnetic field to contain the placement and/or shape of the electric arc generated between the set of continuously-fed electrodes, as an anode, and the cathode.

In some implementations, the engine further includes a drive roller configured to drive the set of continuously-fed electrodes into the plasma chamber. In some implementations, the engine further includes a controller operatively coupled to the drive roller, the controller being configured to adjust the drive roller operation (e.g., feed speed) based on one or more of (i) measured arc voltages, (ii) arc current, or (iii) airflow speed.

In some implementations, the engine further includes a combustion chamber operatively coupled to the compressor stage to receive compressed air from the compressor stage, the combustion chamber including a fuel injection nozzle configured to inject and ignite fuel within the combustion chamber. In some implementations, the plasma chamber and the combustion chamber together form a combustion stage of the engine, wherein the plasma chamber and the electrically conductive plasma generated therein create a first impulse, the combustion chamber and the ignited fuel therein create a second impulse, the ratio of the first impulse to the second impulse being continuously adjustable.

In some implementations, the engine further includes an afterburner stage operatively coupled to the combustion chamber, the afterburner stage including the plasma chamber.

In another aspect, an electrode feeding system is disclosed, the system including a set of continuously-fed electrodes, a drive roller, and a controller. The set of continuously-fed electrodes is configured to be consumed and converted to an exhaustible gas. The drive roller is configured to drive the set of continuously-fed electrodes into a plasma chamber. The controller is operatively coupled to the drive roller, the controller being configured to adjust the drive roller operation based on one or more of (i) a measured arc voltage, (ii) arc current, or (ii) airflow speed, in the plasma chamber.

In some implementations, the electrode feeding system further includes a cathode, the cathode being made of copper or copper metal matrix composite and configured to produce a transverse magnetic field to force an electric arc generated in an airflow stream of the compressed air to rotate.

In some implementations, the set of continuously-fed electrodes, as anodes, includes one of (i) at least one rigid graphite rod drawn from a cassette or (ii) at least one carbon rod drawn from a spool of flexible carbon fiber cable.

In another aspect, a method is disclosed, the method including: receiving, in an engine, input air; compressing, at a first stage of the engine, the input air and reducing input air velocity to generate compressed air; converting the compressed air to an electrically conductive plasma at a second stage of the engine configured to generate an electric arc in an airflow stream of the compressed air, wherein the electric arc is generated with a set of continuously-fed electrodes; and expanding the electrically conductive plasma to generate impulse of the engine, wherein the heat introduced at the first stage of the engine is combined with heat generated at the second stage to contribute to the impulse generation.

In some implementations, the second stage of the engine further includes: injecting a fuel into a combustion stage; and igniting the fuel in the combustion stage to generate an impulse of the engine.

In some implementations, the ratio of the impulse generated by the conductive plasma to the impulse generated by the combustion stage is continuously adjustable.

In some implementations, the method further includes converting the compressed air to an electrically conductive plasma at a third stage (e.g., afterburner stage) of the engine adjacent to a nozzle.

In some implementations, the method further includes feeding the set of continuously-fed electrodes, as anodes, from a spool of flexible carbon fiber cable, wherein the flexible carbon fiber cable is consumed during operation and converted to an exhaustible gas.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIGS. 1A-1B each shows an example air-breathing plasma engine comprising an arc plasma chamber that generates plasma via electrodes continuously fed by an electrode-feeding assembly, in accordance with an illustrative embodiment. In FIG. 1A, the engine is an arcjet engine comprising a compressor that is operatively coupled to the arc plasma chamber. In FIG. 1B, the engine is a turbojet engine comprising a compressor that is operatively coupled to a hybrid combustion arcing chamber.

FIGS. 2A, 2B, 2C, 2D, and 2E each show another engine configuration that includes the arcing chamber or the hybrid arcing chamber.

FIGS. 3A, 3B, 3C, 3D, and 3E each show an example electrode feeder for continuously feeding an electrode anode. Specifically, FIG. 3A shows an electrode feeder for a flexible carbon fiber cable dispensed from a spool, and FIG. 3B shows an electrode feeder for rigid graphite rods, e.g., stored in a cassette, in accordance with an illustrative embodiment. FIG. 3C shows a hybrid engine comprising the electrode feeder for a flexible carbon fiber cable dispensed from a spool. FIGS. 3D and 3E each shows additional configurations for the feeder system.

FIGS. 4A-4B each shows examples of the plasma chamber engines, e.g., FIGS. 1A-1B and 2A-2E, in accordance with an illustrative embodiment.

FIGS. 5A and 5B each show an example configuration for the cathode, in accordance with an illustrative embodiment.

FIGS. 6A and 6B show example controls for the arcing system to operate the plasma-generating elements and ensure the stability of a DC arc.

FIG. 7A shows an experimental setup to evaluate heat transfer process in a plasma chamber according to the working principle of air-breathing arcjet engines.

FIGS. 7B-7C show the simulation zone (region) of the experimental setup.

FIG. 7D shows the absorption coefficients of air for radiation of different wavelengths.

FIGS. 8A-8C shows simulation results for the heat transfer process, including velocity results in a plasma chamber according to the working principle of air-breathing arcjet engines.

FIGS. 9A-9C shows simulation results for the heat transfer process, including temperature results in a plasma chamber according to the working principle of air-breathing arcjet engines.

FIG. 10A shows an example testbed system of a plasma chamber employed in the study.

FIG. 10B shows an example magnetic containment device for the system employed in the study.

FIGS. 11A, 11B, and 11C show an example control for the plasma engine and its associated operations.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in a first list, and “[n′]” corresponds to the reference in a second list. All references cited and discussed in this specification are incorporated herein by reference in their entirety and to the same extent as if each reference was individually incorporated by reference.

### Example System

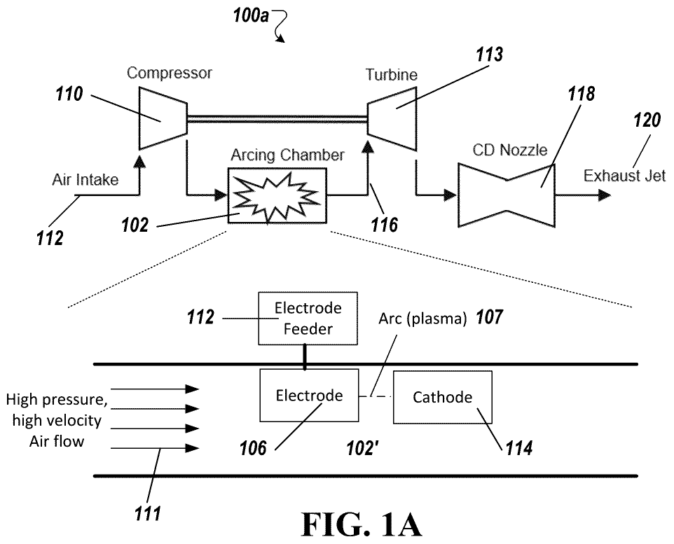

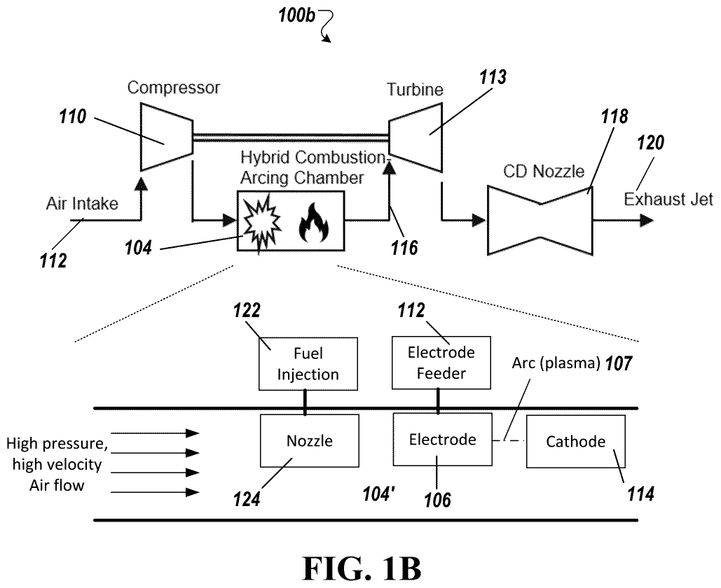

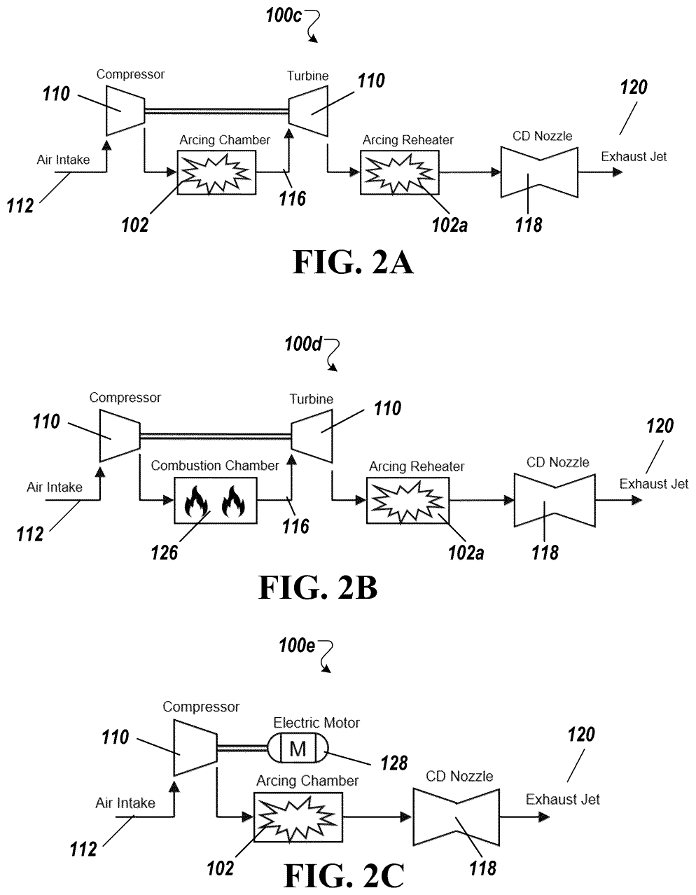

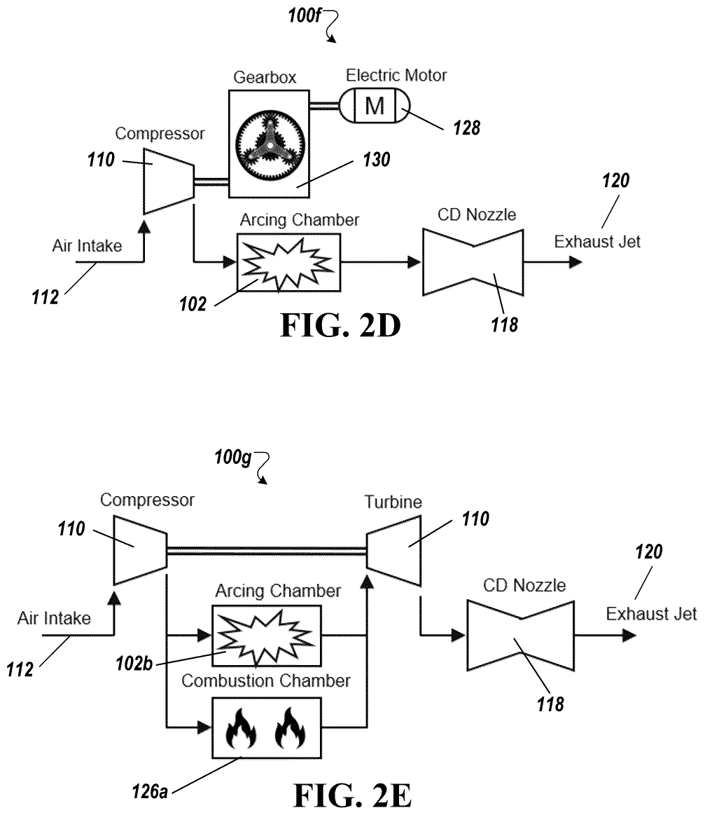

FIGS. 1A-1B and FIGS. 2A-2E each shows an example air-breathing plasma engine 100 (shown as 100a, 100b, 100c, 100d, 100e, 100f) comprising an arc plasma chamber (shown as 102 or 104) that generates plasma (e.g., electrode-coupled, direct current plasma) via electrodes 106 continuously fed by an electrode-feeding assembly 108, in accordance with an illustrative embodiment.

The electrode-feeding assembly 108 can provide replacements of the electrodes that could be subject to electrode wear and erosion as the anode material evaporates and oxidizes during the generation of the plasma and associated electrical arc. In some embodiments, the electrode 106 is a flexible carbon fiber. In other embodiments, the electrode 106 is a graphite rod.

In FIG. 1A, the engine 100a is an arcjet engine comprising a compressor 110 that is operatively coupled to the arc plasma chamber 102. The arcing chamber 102 generates heat that provides impulses to drive a turbine section 113 which is mechanically coupled to compressor 102. In FIG. 1B, the engine 100b is a turbojet engine comprising a compressor 110 that is operatively coupled to a hybrid combustion arcing chamber 104 (also referred to as arcing chamber 104). The arcing chamber 104 also generates heat that provides impulses to drive a turbine section 113 that is mechanically coupled to compressor 110.

FIGS. 2A-2E each shows other engine configurations that include the arcing chamber 102 or the hybrid arcing chamber 104.

In the example shown in FIG. 1A, the arcing chamber 102 (shown as 102′) including an air inlet 108 configured to receive input air. The engine 100a further includes a compressor 110 coupled to the air intake 108. The compressor 110 compresses and input air to increase the pressure and reduce the velocity of the input air. The arcing chamber (e.g., 102, 102′) is operatively coupled to the compressor 110 to receive compressed air 111 from the compressor 110 and includes at least one electrode 106 configured to generate an electric arc 107. The engine 100a further includes an electrode feeding system 112. The electrode feeding system 112 feeds the electrode into the plasma chamber (e.g., 102, 102′) at a position adjacent to a cathode 114 to generate the electric arc 107. The electric arc 107 generated in the plasma chamber 102 converts the incoming compressed air 111 into an electrically conductive plasma and exhausts the plasma along with other byproducts, including the consumed electrode.

The heated air and exhaust 116 from the plasma chamber 102 flows through the nozzle stage 118 (shown as “CD Nozzle” 1189) coupled to and downstream from the plasma chamber 102. The nozzle stage 118 expands the electrically conductive plasma and heated air to generate an impulse or thrust 120 (shown as “Exhaust Jet” 120) at the exit of the engine 100a.

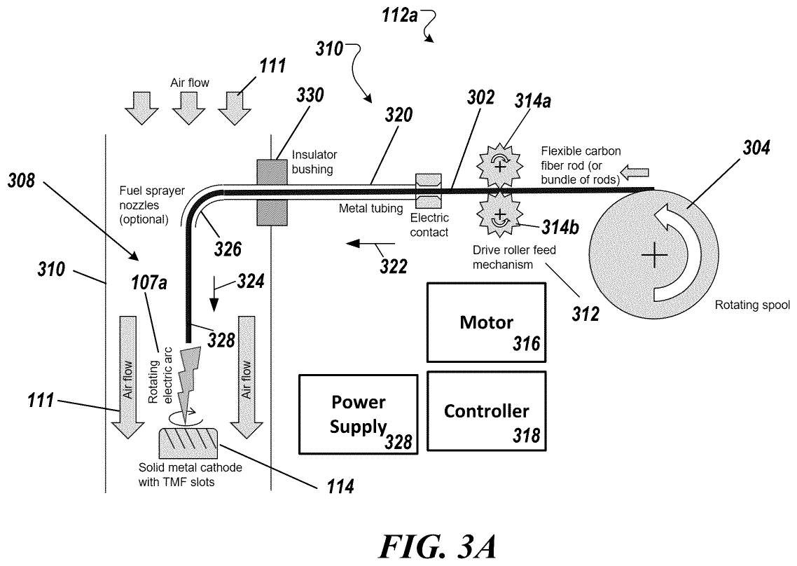

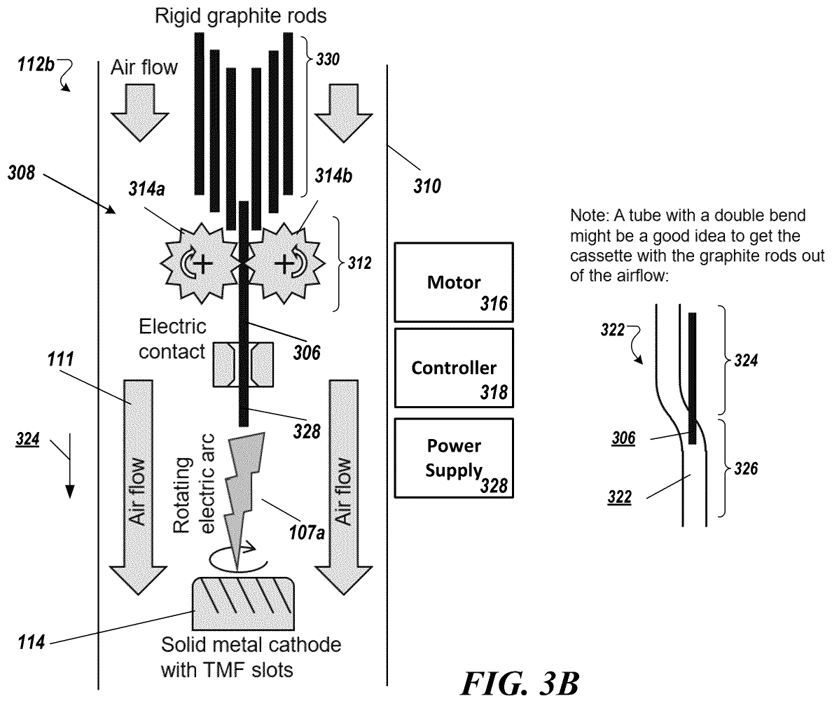

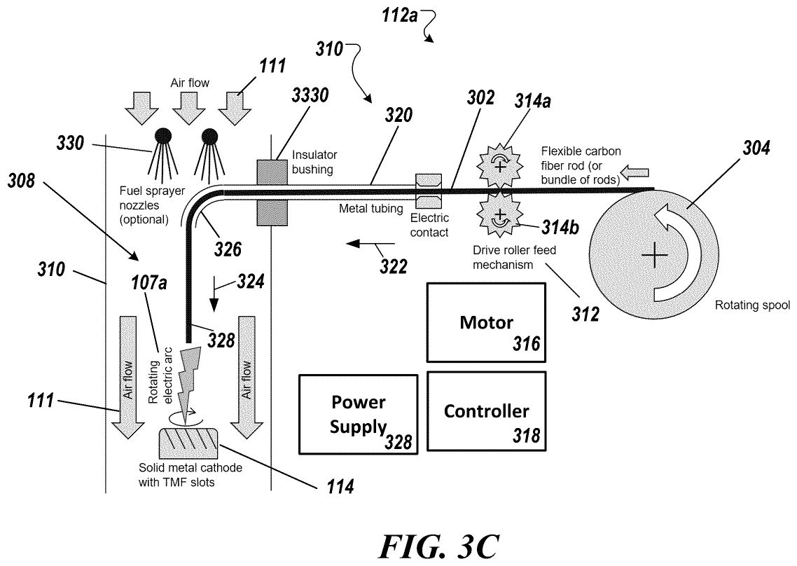

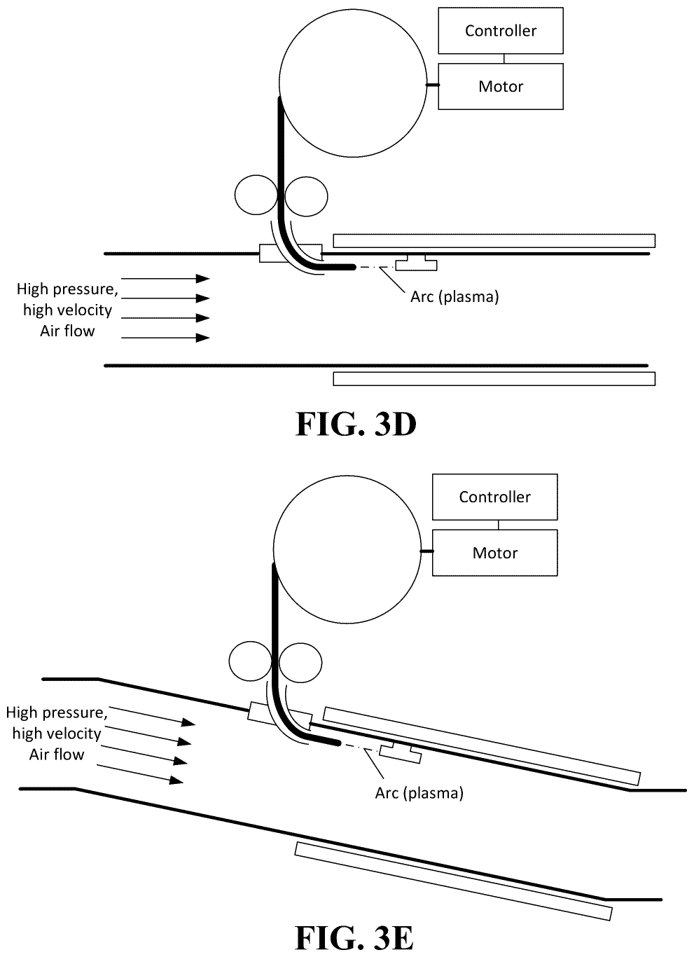

The engine 100a is coupled to a controller 120 (see FIG. 3) that adjusts and controls, among other things, the electrode feeding system in feeding the continuously-fed electrodes 106 into the plasma chamber 102 (e.g., the feed rate of the carbon fiber anode).

In FIG. 1B, the engine 100b is a turbojet engine comprising a compressor 110 that is operatively coupled to a hybrid combustion arcing chamber 104 (also referred to as arcing chamber 104). The arcing chamber 104 also generates heat that provides impulses to drive a turbine section 113 that is mechanically coupled to compressor 110.

The hybrid chamber 104 (shown as 104′) includes a set of electrode 106 that is fed into the chamber by the electrode feeder 112. The electrode 106 operates with the cathode 114 to generate arc (plasma) 107. The hybrid chamber 104 also has a fuel injection system 122 that has a nozzle 124 to introduce fuel into the chamber 104′. The fuel can be ignited by a spark plug (not shown) or by the electrode 106. The combusted mixture is directed towards the electrode 106 to add additional heat to the combusted mixture that is exhausted to turbine 113.

The combustion chamber 104 can be implemented as any number of conventional combustor cans. An aircraft equipped with such an engine could be considered hybrid-electric, allowing pure electric operations in certain flight regimes such as cruise and taxiing while using a combination of electric and jet fuel during phases with higher thrust requirements such as takeoff and climb.

FIGS. 2A-2E each shows other engine configurations that each includes the arcing chamber 102.

FIG. 2A shows an engine 100c, e.g., as an arcjet engine, similar to that of FIG. 1A, that operates entirely by plasma and includes a second plasma chamber 102 (shown as “arcing reheater” chamber 102a). The reheater chamber 102a may be similarly configured as chamber 102′. The reheater chamber 102a is configured to introduce additional heat into the system via an electric arc that forms additional plasma. The electrically conductive plasma heats the exhaust gases that then exit the nozzle stage 118.

FIG. 2B shows an engine 100D, e.g., a turbojet engine, that includes a combustion chamber 126 that operates via hydrocarbon combustion and additionally includes a plasma chamber 102 (shown as “arcing reheater” chamber 102a). The reheater chamber 102a may be similarly configured as chamber 102′. The reheater chamber 102a is configured to introduce additional heat, e.g., into the convention stream output of a turbofan engine.

In some embodiments, the arcing reheater 102a can be configured as an afterburner, e.g., by being placed after the nozzle 118.

FIGS. 2C and 2D each shows an engine 100e and 100f, respectively, e.g., an electric engine, that includes an electric motor 128 to drive the compressor 110 instead of a turbine (e.g., 113). The engine 100e includes a plasma chamber 102 similar to that shown in FIGS. 1A and 2A. In FIG. 2C, the electric motor 128 is mechanically linked to the compressor 110. In FIG. 2D, the electric motor 128 is mechanically linked to the compressor 110 through a gearbox 130. The gearbox 130 can drive the output of the electric motor 128 to a prescribed speed, e.g., between 3,000 RPM and 200,000 RPM. The gearbox 130 can be configured with a gear ratio of 2:1, 3:1, 4:1, 5:1, 6:1, 7:1, 8:1, 9:1, 10:1. In some embodiments, the ratio is greater than 100:1.

FIG. 2E shows an engine 100g, e.g., as an arcjet engine, similar to that of FIG. 1A that operates by both plasma and combustion and includes both an arcing chamber 102 (shown as 102b) and a combustion chamber 126 (shown as 126a). The arcing chamber 102b and combustion chamber 126a are configured in a parallel configuration to allow for the independent operation of the two chambers (102b, 126a) that are fed from the same compressor stage. The outlet from the compressor stage may be at a same section of the compressor stage or in different sections. In some embodiments, the arcing chamber 102b and combustion chamber 126a are configured to operate simultaneously to one another in which one engine can optimally operate for a given flight envelope, e.g., the combustion chamber 126a operating at lower altitude operations and switch over the arcing chamber 102b for higher altitude operations. In a configuration, one of the chambers (102b, 126a) is operating at any given time. In another configuration, both chambers (102b, 126a) are operating at the same time during any flight operation, but the amount of power generated by each can be adjusted for the current altitude or flight condition. In some embodiments, the arcing chamber 102b can be enabled when additional power is needed (e.g., similar to an afterburner).

### Example Electrode Feeding System

FIGS. 3A and 3B each show an example electrode feeder 112 (shown as 112a and 112b, respectively) for continuously feeding an electrode anode. Specifically, FIG. 3A shows an electrode feeder 112a for a flexible carbon fiber cable dispensed from a spool, and FIG. 3B shows an electrode feeder 112b for rigid graphite rods, e.g., stored in a cassette. Because of the electrode wear and erosion as the anode material evaporates and oxidizes during the generation of the plasma and associated electrical arc, the electrode has to be replenished to ensure proper operation. Rather than replacing the electrode, e.g., between each flight, the electrode feeder 112 provides for the continuous operation of the engine and treats the electrode as a consumable similar to welding wire (e.g., employed in metal inert gas (MIG) welding).

In FIG. 3A, the feeder system 112a can continuously feed the electrode 106 into the plasma chamber (e.g., 102, 104) as a flexible carbon fiber rod 302 that is un-spooled from a spool 304. In FIG. 3B, the feeder system 112b can continuously feed the electrode 106 into the plasma chamber (e.g., 102, 104) as a straight graphite rod 306 that is dispensed from a cassette storage bin.

Because flexible carbon fiber rods 302 (FIG. 3A) tend to have lower electrical conductivity, e.g., compared to graphite rods (e.g., FIG. 3B), thicker fiber rods can be utilized at a trade-off of a thicker minimum bending radius. To reduce the minimum bending radius, the flexible carbon fiber rods 302 can be composed of a bundle rod filaments with smaller thicknesses and the filaments are then bundled to form a larger cross-section structure.

Flexible Carbon Fiber Rod Electrode Feeder. In FIG. 3A, the feeder system 118a includes a rotating spool 304 containing a flexible carbon fiber rod 304. The carbon fiber rod 304 acts as the anode in the plasma-generating process. The rotating spool 304 is disposed outside of the plasma chamber (e.g., 102, 104; shown as 308) defined by sidewalls 310. As described in relation to FIGS. 1A, 1B, 2A-2E, the sidewalls 310 may be a portion of a combustion chamber (e.g., FIG. 1B) of the engine, a plasma-only chamber (e.g., FIG. 1A), a reheater chamber (e.g., FIG. 2B), or other portions of the engine disposed downstream of the compressor stage, e.g., afterburner. An example of the carbon fiber rod is the micro pultruded solid carbon rods (e.g., manufactured by Goodwinds Components).

The flexible carbon fiber rod 302 is fed from the rotating spool 304 via a drive roller feed assembly 312 having two rotating drive roller feeders (shown as 314a, 314b). The drive roller assembly 312 includes a first roller 314a and a second roller 314b, each rotatable to engage and translate the flexible carbon fiber rod 302 in a first direction (e.g., substantially perpendicular to the direction of airflow through the plasma chamber) into the plasma chamber 308. The driver roller 312 is driven by a motor assembly 316 that is operatively connected by a controller 318. The motor assembly 316 may be coupled to one of the drive roller feed 314a, 314b, or both. In some embodiments, a single motor drives both roller feeds 314a, 314b across a set of gear.

The drive roller 312 and motor 316 are each disposed outside of the plasma chamber 308. Multiple drive roller assemblies (e.g., 312) may be implemented (not shown).

The drive roller assembly 312 feeds the flexible carbon fiber rod 302 through a curved conduit 320 (shown as “Metal tubing” 320) that guides and introduces the flexible carbon fiber rod 302 from a space outside the plasma chamber 308 (though within the engine structure) moving in a first direction 322 through the chamber wall 310 into the plasma chamber 308 that then curves or bends into a second direction 324. The second direction 324 can be substantially parallel to the direction of airflow 111 moving through the plasma chamber 308. To maintain arc stability and provide a stable arc 107a, the arc 107a would be formed in a direction parallel, or substantially parallel, to the air flow 308. The distal end 326 of the conduit 320 introduces the flexible carbon fiber rod 302 into the plasma chamber 308 to be in electrical contact, in the form of the arc 107 (shown as “rotating electrical arc” 107a), with the cathode 114.

The system 112a further includes a cathode 114 (e.g., a copper cathode) disposed within the plasma chamber 308. The distal end 326 of the flexible carbon fiber rod 304 moves towards the cathode 114 to reach a critical distance to generate the electrical arc 107a between the cathode 114 and the flexible carbon fiber rod 302. The electrical arc 107a generates plasma within the plasma chamber 308 and converts compressed air 326 flowing through the plasma chamber 308 into electrically conductive plasma.

The cathode 114 provides the electrons for the arc and, in contrast to the flexible carbon fiber rod 302, is not consumed during runtime operation as long as the surface does not evaporate and does not react with constituents of the air. The cathode 114 may be formed of copper, which provides low electrical resistivity, high thermal conductivity, and low oxygen affinity. It can be constructed to reject heat convectively into the airflow or cooled by a separate system such as a cooling loop (not shown) (e.g., water cooling loop or aircraft fuel cooling loop). Solid graphite may be another choice of materials for the cathode 114 due to the very high melting point of carbon (e.g., 3,642° C.) compared to copper's 1,085° C. However, a high melting point is not the only requirement, as solid graphite can oxidize and burn away.

For high arc currents (Lorentz force) and high air densities (high compression ratio), the arc would be concentrated to a small cathode surface area. In some embodiments, to distribute the heat and reduce cathode wear, the system may spin the arc in a circular manner. In some embodiments, the cathode 114 may include geometric features (e.g., groove, slots) to direct the electric current and its magnetic field similar to transverse magnetic field (TMF) contacts in a vacuum interrupter. An external magnetic field could achieve a similar effect and would also allow for external control as a function of cathode surface temperature. To generate the magnetic field, the system may include electrical coils or magnets (not shown) located near the arc 107a.

The resulting exhaust generated from the interaction between the cathode 114 and flexible carbon fiber rod 302 is carbon dioxide, which is non-toxic and gaseous, both being important for an application in electric passenger aircraft. The total heat produced is mainly from the electric arcing and only to a minor degree from the oxidation of carbon. This can substantially lower greenhouse gas emissions compared to turbojet engines that operate purely chemically from liquid hydrocarbon fuels.

The arc's magnetic self-field contributes to stability (Lorentz force). The arc is oriented in line with the airflow, with the anode (e.g., 302) being upstream and the cathode (e.g., 114) being downstream so that the ionized carbon particles travel with the flow of air. For long arc lengths and high-speed turbulent airflow, the self-field might not be sufficient to keep the arc stable, and additional focusing magnet systems might be required. An example of such a focusing magnet system is the quadrupole, which generates magnetic field gradients that direct charged particles to its center.

The feeder system 118a integrates with an arcing system comprising a power supply 328 that supplies DC power to the flexible carbon fiber rod 302. To generate the arc 107a, at least a DC voltage of 55 V is provided. The DC voltage can be between 55 VDC and 1000 VDC, e.g., about 55 VDC, 60 VDC, 65 VDC, 70 VDC, 75 VDC, 80 VDC, 85 VDC, 90 VDC, 95 VDC, 100 VDC, 110 VDC 120 VDC 130 VDC, 140 VDC, 150 VDC, 160 VDC, 170 VDC, 180 VDC, 190 VDC, 200 VDC, 210 VDC 220 VDC 230 VDC, 240 VDC, 250 VDC, 260 VDC, 270 VDC, 280 VDC, 290 VDC, 300 VDC, 310 VDC 320 VDC 330 VDC, 340 VDC, 350 VDC, 360 VDC, 370 VDC, 380 VDC, 390 VDC, 400 VDC, 410 VDC 420 VDC 430 VDC, 440 VDC, 450 VDC, 460 VDC, 470 VDC, 480 VDC, 490 VDC, 500 VDC, 510 VDC 520 VDC 530 VDC, 540 VDC, 550 VDC, 560 VDC, 570 VDC, 580 VDC, 590 VDC, 600 VDC, 610 VDC 620 VDC 630 VDC, 640 VDC, 650 VDC, 660 VDC, 670 VDC, 680 VDC, 690 VDC, 700 VDC, 710 VDC 720 VDC 730 VDC, 740 VDC, 750 VDC, 760 VDC, 770 VDC, 780 VDC, 790 VDC, 800 VDC, 810 VDC 820 VDC 830 VDC, 840 VDC, 850 VDC, 860 VDC, 870 VDC, 880 VDC, 890 VDC, 900 VDC, 910 VDC 920 VDC 930 VDC, 940 VDC, 950 VDC, 960 VDC, 970 VDC, 980 VDC, 990 VDC, 1000 VDC. In some embodiments, the DC voltage is greater than 1000 VDC. The arc is a function of the voltage level and distance gap as well as air condition (e.g., air pressure and velocity). Power supply 328 may include a DC-to-DC converter (e.g., bulk or boost converter) configured to step up the internal voltage of energy storage in the aircraft to the desired output voltage. The flexible carbon fiber rod 302, metal conduit 320, and spool 304 can be energized with DC voltage. In some embodiments, the power supply 328 is electrically coupled to the flexible carbon fiber rod 302 through an electrical contact coupled to the metal conduit 320, e.g., as terminals located on the metal conduit 320. In other embodiments, the power supply 328 is electrically coupled to the flexible carbon fiber rod 302 through the spool 304, e.g., at terminals located on the metal conduit 320. The metal conduit 320 may be insulated from the aircraft airframe via insulator bushing 330. Similarly, the spool 304 may be coupled to the aircraft frame via an insulating coupling.

The system 300a includes a controller 318 operatively coupled to the driver mechanism 312 (e.g., via motor 316). The controller 318 is configured to operate the drive mechanism 312 (e.g., the speed of rotation or the torque applied). The controller 318 may adjust the operation of the drive mechanism 310 based on measured arc voltage, arc current, and/or airflow speed in the plasma chamber 308. In other implementations, the controller 318 may receive data from the aircraft avionics to adjust the drive mechanism 312 or power supply 328. For example, the controller 318 (or aircraft avionics) may incorporate a variety of operating conditions for the airbreathing plasma jet engine, e.g., intended or desired Mach number, chamber pressure, chamber temperature, mass flow rate, throat temperature, throat air density, throat air velocity, throat area, exit area, exit velocity, thrust, compressive power, and heating power.

FIG. 3C additionally shows the fuel 330 can be introduced into the air flow 111 upstream to the arc 117a, e.g., via fuel injection system 122 (FIG. 1B).

Cassette feeder system. As noted above, FIG. 3B shows the feeder system 112b that can continuously feed the electrode 106 into the plasma chamber (e.g., 102, 104) as a straight graphite rod 306 that is dispensed from a cassette storage bin 330. The cassette feeder system 112b includes similar features to the flexible carbon rod feeder system described in relation to FIG. 3A but can beneficially operate on graphite rods. Graphite rods (e.g., 306) beneficially have higher conductivity property as compared to carbon rods (e.g., 302) but are not flexible or bendable. To employ the graphite rods, the electrodes 106 can be in sections that are then fed into the plasma chamber 308.

In addition to the small amount of carbon dioxide CO₂ that is emitted due to the oxidation of the carbon anode, there are other emissions to consider. For example, incomplete combustion of carbon could lead to carbon monoxide CO emissions. In addition, the high-temperature conditions in the arc chamber can create reactions with the constituents of air, e.g., to form nitrogen oxides NOx as well as ozone O₃. However, compared to hydrocarbon combustion, CO₂ emissions would be greatly reduced in addition to water vapor. Water vapor in the higher atmosphere can contribute to the formation of contrails, which are considered to contribute to global warming.

Like any other turbojet engine, the here-proposed engine follows the Brayton cycle. The thermodynamic efficiency of the Brayton cycle is defined per Equation 1.

$$η = 1 - \frac{{T}_{1}}{{T}_{2}} = 1 - {( \frac{{P}_{1}}{{P}_{2}} )}^{\frac{γ - 1}{γ}} \qquad ( Eq . 1 )$$

The efficiency of practical implementations is limited by the maximum temperature that the turbine can tolerate. It is therefore expected that the efficiency is similar to today's turbojet (turbofan) engines. While this might appear low compared to electric motors, the whole system needs to be considered. Furthermore, the benefit of high-power density of turbojet engines needs to be considered.

In FIG. 3B, the includes a feeder system 112b is shown located upstream (e.g., in a compartment within the plasma chamber 308) from the arc region to provide the electrode 106 to be in proximity with the cathode 114. To place the feeder system 112b outside the plasma chamber 308, the feeder system 112b may be placed in a section of the engine having a curved plasma chamber 322 that allows the feeder system 112b to be housed in a first section 324 of the chamber to introduce the graphite rod 306 as electrode 116 into a second section 326 in the plasma chamber 322.

The plurality of rigid graphite rods 306 may include, for example, discrete graphite rods of a standard length arranged to be inserted into a plasma chamber (e.g., 308 or 322) one by one into the drive roller feed 312. The drive roller feed 312 is arranged to feed one of the plurality of rigid graphite rods 306 in parallel to the direction of airflow 111 (e.g., the second direction 324). For example, the plurality of rigid graphite rods 306 may be disposed within a cassette or other housing having an opening to allow a single graphite rod 306 to be dispensed. The drive roller mechanism 312 may engage with and pull the graphite rods 306 from the cassette through a port formed in the plasma chamber wall or feeder compartment towards the cathode 114.

FIGS. 3D and 3E each shows additional configurations for the feeder system (e.g., 112a). In FIG. 3D, the feeder system 112a is disposed in an engine having a horizontal air flow through a horizontal plasma chamber rather than a vertical one, e.g., as shown in FIG. 3A. in FIG. 3E, the feeder system 112a is disposed in an engine having an angled air flow through an angled plasma chamber rather than a vertical one, e.g., as shown in FIG. 3A. In each of these instances, the air flow is still substantially parallel to arc formed between the electrode 112 and the cathode 114.

### Example Plasma Chamber Engine

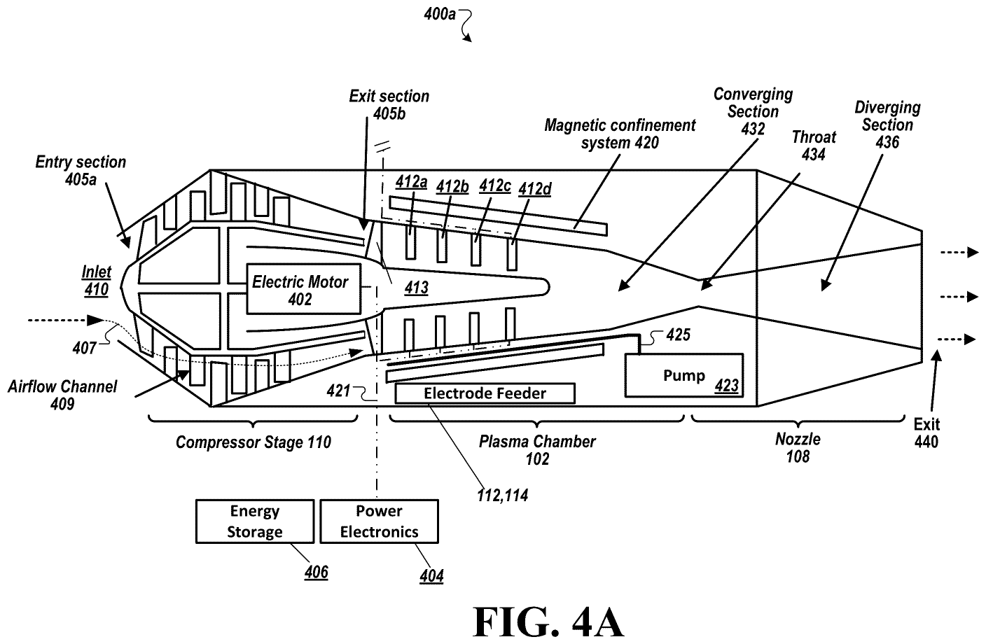

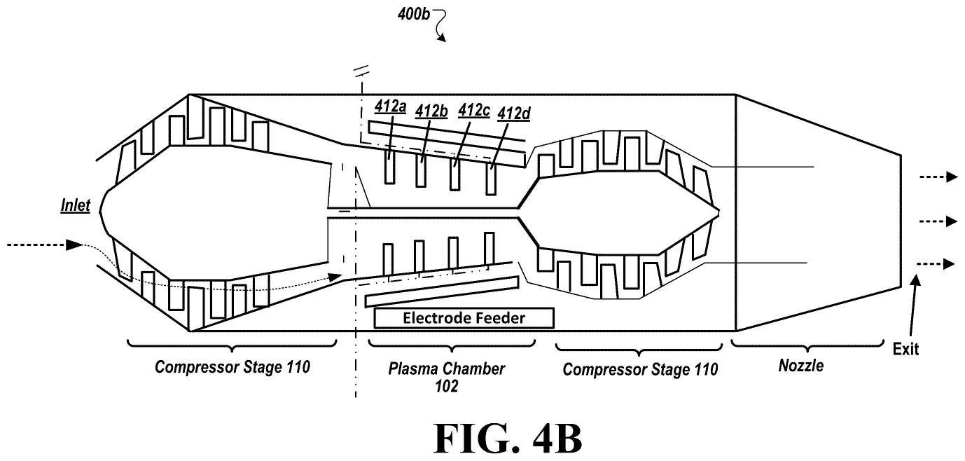

FIGS. 4A-4B each shows an example of the plasma chamber engines, e.g., FIGS. 1A-1B and 2A-2E. In FIG. 4A, the engine 400a includes the compressor 110 and a plasma chamber 102. The compressor 110, in this example, is driven by an electric motor 402, e.g., as shown in relation to FIG. 2C or 2D. in FIG. 4B, the engine 400b includes the compressor 110 that is mechanically coupled to a turbine section 113, e.g., as described in relation to FIG. 1B, 2A, 2B, etc.

In the example shown in FIG. 4A (and FIG. 4B), the engine 400a includes a compression stage 110 coupled to an electric motor 402, a plasma chamber 102, and a nozzle 118. A multiple-stage compressor 110, similar to a conventional turbojet engine, may be employed. Multiple compressors can increase the cost of the system and its maintenance and its performance. A trade-off between cost from the number of compressor stages and the rotating speed and resulting air velocity can be made while providing the prerequisite compression ratio (e.g., 20:1, 60:1, 80:1, or higher).

Higher air velocity can be attributed to the corrosion of the electrodes 106 located downstream to the compression stage 110. The heat generated from the compression, while typically considered as a byproduct of the compression, may be captured and reused in the plasma chamber (e.g., 102, 104) to be used to ultimately generate thrust. In the example shown in FIG. 4A, 7 compressor stages are shown. In other implementations, the air-breathing plasma jet engine 400a may have 2, 3, 4, 5, 6, 7, 9, 10, or more stages. Unlike conventional turbojet engines, in FIG. 4A, the plasma chamber (e.g., 102) is configured to direct compressed, heated air out of the nozzle. No turbine section is employed in the later stage of the plasma chamber, which is superheated, to generate thrust.

In the example shown in FIG. 4A, the electric motor 402 is housed in the front central section of the engine 400a.

In FIG. 4A (and FIG. 4B), multiple stages of electrodes 106 (shown as 412a, 412b, 412c, and 412d stages) may be employed, each configured to ionize (with a cathode 114) the compressed air outputted from the compression stage 110 to introduce inductively coupled plasma currents as heat into the chamber 102. The engine 400a (and 400b) further includes an electrode feeding system 112, 114 (e.g., as shown in FIG. 1A or 1B) adjacent to the plasma chamber 102. The electrode feeding system 112, 114 feeds the electrode (e.g., flexible or rigid carbon fiber or graphite rod, or one or more of the electrodes 412a-412d) into the plasma chamber 102 adjacent to a cathode to generate the electric arc.

The electric motor 402 and electrodes 106 may be operatively coupled via cables 412 to two or more power electronic modules 404 (e.g., power supply 328). A first set of one or more power electronic modules may be configured to drive the electric motor 402. A separate power electronic module(s) is configured to drive the electrodes 106. Each stage of the electrodes 106 may include 1, 2, 3, 4, 5, 6, 7, 8, 9, 10, 11, or 12 number of electrodes. The power electronic modules are operatively coupled to energy storage 406 (e.g., batteries). The power electronic modules 404 may be positioned in the engine 400a, or they may be positioned in other regions of the aircraft (e.g., in the wing).

Cooling, e.g., film cooling, boil-off cooling, or conventional vein cooling (heat exchanger) in turbo jet systems, may be employed to regulate the surface temperature of the chamber 102. In FIG. 4A (and FIG. 4B), the engine 400a (and 400b) may include a pump 423 coupled to heat-exchanging veins 425 that are built into the housing of the plasma chamber 102.

In FIG. 4A (and FIG. 4B), the engine 400a (and 400b) includes an inlet 410 (shown as “intake” 410) configured to receive input air. The inlet 410 can be in line with an axis of the compressor stage 110. The inlet 410 and compressor 110 are configured to increase the compression ratio and/or heating of the input air 407. Through the compression, the air is compressed and heated.

The air 403 from the inlet 410 enters the compressor stage 110 which is configured with one or more compressors (shown as “impeller”) driven by an electric motor 402 to compress the incoming air 407. The electric motor 128 includes a rotor and a stator, e.g., configured as a high-speed synchronous motor. In some embodiments, a stator is coupled to a gearbox. The electric motor 402 (and gearbox) may drive the compressor 110 at a speed between 3,000 RPM and 200,000 RPM to provide a high compression ratio (e.g., 20:1, 60:1, 80:1, or higher). The electric motor 402 is preferably positioned in the engine. In other embodiments, the motor can include coils (not shown) that are positioned outside the airflow channel.

The motor 402 may be coupled to a radial compressor, an axial compressor, or another compressor described herein. A radial compressor (e.g., centrifugal compressor) includes airfoils or blades configured to rotate to move gas or working fluid non-parallel to an axis of rotation of the airfoils or blades. An axial compressor includes airfoils, impellers, or other blades configured to rotate to move gas or working fluid parallel to an axis of rotation of the airfoils or blades. Combinations of axial and radial compressors can be used to form the compressor stage 102x (e.g., a diagonal compressor, also referred to as a mixed flow compressor), and any number of axial and/or radial compressors can be used to form the compressor stage 110 (e.g., multiple compressors can be arranged in series to increase the amount of compression, or multiple compressors can be arranged in parallel to increase the airflow).

The compressor stage 110 is defined by an entry section 405a and an exit section 405b. The compressor stage 110 can both compress the input air and reduce the input air velocity. That is, the air 407 at the exit section 405b of the compressor stage 110 is both slowed and compressed when compared to the air at the entry section 405a of the compressor stage 110. The compressor stage 110 includes an airflow channel 409. Alternatively, the motor 402 can be positioned outside the airflow channel 409.

The plasma chamber 102 is configured with (i) a set of electrodes 106 (shown as “Arc” 412) configured to introduce inductively-coupled plasma currents as heat into the chamber 102 by ionizing the compressed air from the compressor 110 and (ii) a thermal cooling or isolation system 420 (shown as “Z-pinch coil” 420), e.g., magnetic containment system to generate a magnetic field to confine plasma generated in the plasma chamber.

The engine 400a (and 400b) further includes an electrode feeding system 112, 114 adjacent to the plasma chamber 102. The electrode feeding system 112, 114 feeds the electrode (e.g., flexible or rigid carbon fiber or graphite rod) into the plasma chamber 102 adjacent to a cathode (not shown) to generate the electric arc.

Notably, the heat generated at the compressor stage 110 due to the compression of the input air 103 can pass to the plasma chamber 102 and be combined with heat introduced therein. The heat from the electrodes 106 and heat from the compressed air are combined in the plasma chamber 102 to a super-high temperature (e.g., 2000° K−3000° K) to form plasma. To withstand the high temperature, magnetic containment system 420 may be employed to insulate the heat from the interior surface of the chamber 102. Secondary cooling, e.g., film cooling, boil-off cooling, or conventional vein cooling (heat exchanger) in turbojet systems, may be employed to regulate the surface temperature of the chamber 102. To withstand the high temperature and corrosion from the air, the electrodes (e.g., the cathode) may be made of a high-purity copper. In other implementations, the cathode may be composed of graphite or metal matrix composite materials having a low melting point (e.g., copper tungsten, copper tungsten carbide, silver tungsten, or silver tungsten carbide).

The electrode 106 may be supplemented with other heat sources, e.g., a microwave generator or an inductively-couple AC heater configured to direct microwave radiation into the plasma chamber to further heat the air.

The plasma chamber 102 is fixably coupled to the nozzle 118 (also referred to as the nozzle stage). The nozzle stage 118 is configured to increase the velocity of the escaping air as the air passes from the converging section 432 to the exit 440 by converting the heat and compressed air into the impulse of the air-breathing plasma jet engine. The nozzle 108 includes a convergent portion 432, a throat region 434, and a divergent portion 436. An example of a convergent-divergent nozzle is a De Laval nozzle. The throat 434 is narrower than the converging 432 and diverging sections 436. The nozzle stage 108 can further include bleed-air cooling, ablative cooling, regenerative cooling, and/or magnetic confinement. Example geometries for the diverging section 436 of the nozzle 108 include conical, parabolic, and bell geometries. Similar to a rocket engine nozzle, nozzle 108 is a propelling nozzle that can expand and accelerate combustion products to high supersonic velocities.

Embodiments of the present disclosure can be used in electric aircraft. The system may also be used to launch vehicles into space (e.g., as part of a single-stage-to-orbit vehicle). As an example for a small-scale demonstrator (e.g., 300 kW engine), the impeller may employ a Garrett type G25-550 configured to operate at an impeller speed between 120 Krpm and 180 Krpm, that can provide 2.3 Nm impeller torque at 120 Krpm, 160-320 g/s impeller mass flow, with a compression ratio of 2.5-3.5. In transitioning to a full-scale engine or larger-scale demonstrator, the compression ratio can be increased, and the rotation speed can be reduced with larger blades and more compression stages.

Besides the conventional turbojet configuration, other types of turbojet-based engines could be realized, including turbofans, geared turbofans, turboprops, and propfans. These are known to strike a good balance between thermodynamic efficiency and power density. The proposed concept applies to these types of engines, too.

Plasma Considerations. Air plasma can be maintained by several methods, including conductive coupling (DC or AC arc), inductive/magnetic coupling, and radiative coupling. Conductive coupling works by passing an electric current through the plasma by means of a pair of electrodes. At high air densities and direct current excitation, the Lorentz force keeps the plasma to a filamentary dimension, i.e., an electric arc. This does not change significantly under low-frequency AC conditions. At radio frequencies, the power can be coupled inductively such as is done in Tokamak fusion reactors. At even higher frequencies, microwave excitation heats the plasma by radiative coupling and is another option to maintain the air in an ionized state. Each of these types of coupling has its own characteristics and advantages (e.g., with respect to electrode consumption, plasma/supply power density, stability under high-speed flow, and control).

Considering the requirement to maximize power density for aero-propulsion applications, the focus is currently on conductively coupled DC plasma, i.e., electric arcing. Since arcs are typically filamentary, i.e., two-dimensional, heat transfer is more challenging compared to a volume heat source.

For the development of an air-breathing propulsion engine based on an electric arc, decades of arc jet development can be leveraged. In particular, research around stabilizing the arc in high mass-flow engines, and techniques to increase the efficiency of thermal transfer to the gas can be utilized.

For the highest power density, the DC electrode-coupled plasma is chosen. This means that anode material is consumed by the arc, i.e., turned into an electrically-charged metal vapor and eventually oxidized in the airflow. The electrode consumption is strictly linear with the plasma current and independent of the arc voltage. Since this arc is in high-speed airflow, the metal vapors will mostly react with air constituents, especially oxygen, and form metal oxides. To avoid solid particles, which would lead to erosion and potential health and environmental hazards, carbon (graphite) is chosen as the cathode material since it forms the gas carbon dioxide CO₂. As it leaves the cathode, it releases four electrons. For each mole of carbon (12 grams), 4 N_{A} electrons are released, equivalent to a total charge of 4 N_{A} qₑ, with N_{A} being Avogadro's constant and qₑ the elementary charge. For a given current I₀, the electrode consumption rate can be defined per Equation 2, e.g., about 31.1 mg/s (or 112 g/h) for a current of 1 kA.

$$\frac{dm}{dt} = \frac{{I}_{0} \cdot M}{4 {q}_{e} \cdot {N}_{A}} \qquad ( Eq . 2 )$$

Assuming equilibrium conditions, the electrical heating power in the arc is the product of arc voltage and arc current plus the losses in the electrodes (mostly in the carbon electrode) per Equation 3.

$${P}_{el} = {V}_{arc} {I}_{0} + {I}_{0}^{2} {R}_{el} \qquad ( Eq . 3 )$$

The voltage is the sum of the cathode fall, the typically significantly smaller anode fall, and the resistive voltage drop along the arc (also known as the arc constriction zone). Therefore, for a given heating power, higher voltages are preferred over higher currents since the electrode consumption is independent of voltage.

To obtain the total heating power, the enthalpy of the chemical oxidation reaction of carbon Pₒₓ can be determined per Equation 4, e.g., with an enthalpy of combustion of ΔH⁰=−393 KJ/mol for the direct and complete oxidation of carbon into CO₂.

$${P}_{ox} = \frac{dm}{dt} \cdot \frac{Δ {H}^{0}}{M} = \frac{{I}_{0} \cdot Δ {H}^{0}}{4 {q}_{e} \cdot {N}_{A}} \qquad ( Eq . 4 )$$

For an efficient plasma jet with low CO₂ emissions, high arcing voltages are beneficial. The ratio of electrical heating to chemical heating may be defined per Equation 5.

$$η = \frac{{P}_{el}}{{P}_{ox} + {P}_{el}} \qquad ( Eq . 5 )$$

For a combustion-based jet engine, Pₑₗ=0, hence η=0. To give an example for electric propulsion, for a given arc voltage of V_{arc}=1,000 V and a current of I₀=1,000 A, there is 980 times more power delivered by the arc than by the chemical oxidation process.

### Example Cathode Design

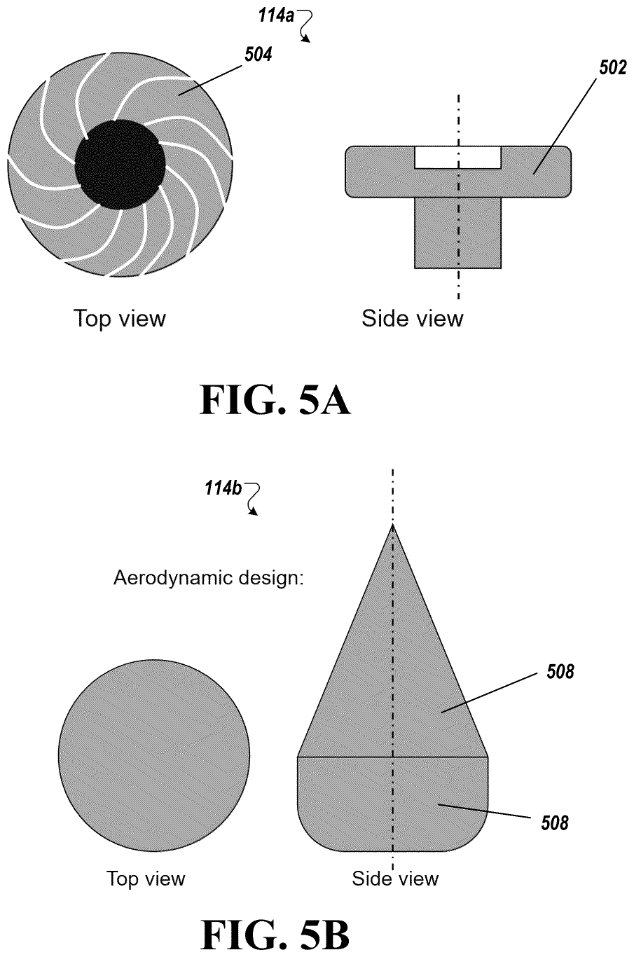

FIGS. 5A and 5B each shows an example configuration for the cathode (e.g., 114). In FIG. 5A, the cathode 114 (shown as 114a) includes arc section 502 having geometric features, e.g., groove, slots 504, to direct the electric current and a transverse magnetic field, e.g., to cause rotation of the arc. The cathode may be formed of copper or other materials described herein.

FIG. 5B shows another configuration of the cathode 114 (shown as 114b) as an aerodynamic structure having a front tapered portion 508 and a curved trailing section 510.

### Example Control System

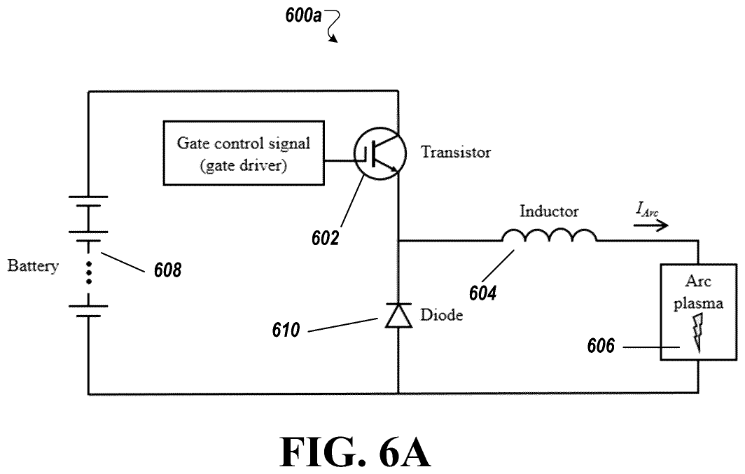

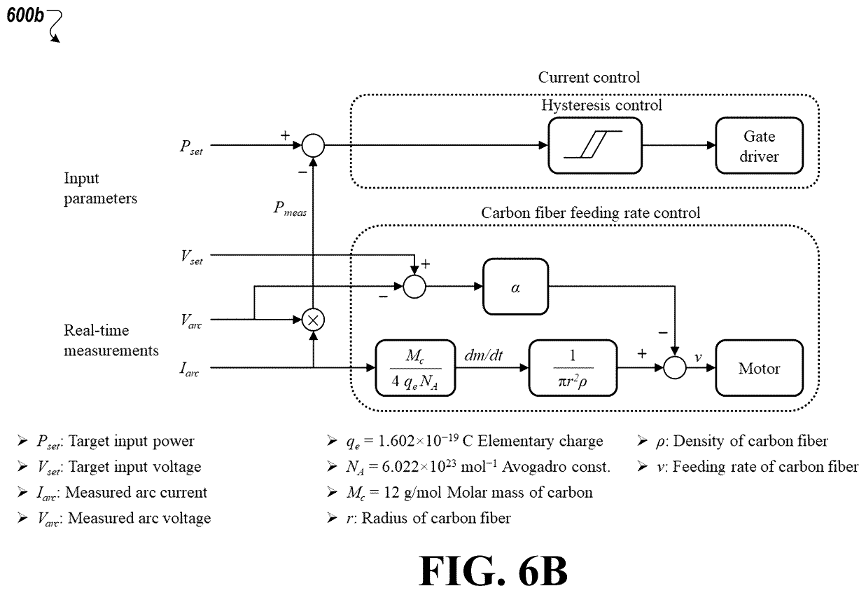

FIGS. 6A and 6B show example controls for the arcing system to operate the plasma-generating elements and ensure the stability of a DC arc. FIG. 6A shows a fully controllable current source implemented with a buck converter to regulate the arc current. The buck converter includes a transistor 602, an inductor 604, a voltage source 608, and a diode 610. A gate control signal from the controller 312 can drive a gate driver to drive the transistor 602. The input and output of a buck converter are both direct current.

In some embodiments, a three-phase rectifier may be used to rectify three-phase AC power. The direct voltage obtained by rectifying three-phase AC power contains ripples.

Digital Logic Controller. FIG. 6B shows an example PI controller for the converter of FIG. 6A. The controller includes as its input, the arc current (power supply in constant current mode), the feed speed (motor voltage), and the ambient/chamber pressure and temperature. The output includes the thrust. Constants that may be employed in the controller include the inertia of motor, thermodynamic efficiency, and rotor speed-to-thrust curve.

The output current of the buck converter can be controlled using an IGBT (Insulated Gate Bipolar Transistor), which functions as a rapidly controllable switch. When the IGBT is turned on, the switch current may flow through the IGBT, inductor, and the arc load. Due to the energy storage property of the inductor, the current continuously rises. When the IGBT is turned off, as indicated by the black line in the left diagram, the switch current flows through the inductor, the arc load, and the diode below. Since the IGBT is off, the current decreases.

Hysteresis control may be used. When the current exceeds a first threshold, the IGBT is turned off to decrease the current. Conversely, when the current falls below a second threshold, the IGBT is turned on to increase the current. This ensures that the current remains stable within the band formed by the red and blue lines. By employing this method, effective control of the current can be achieved.

By adjusting the proportion of time, the IGBT is turned on during its switching cycle, known as the duty cycle of the PWM signal, the controller can control the current. A higher duty cycle can increase the ability of the PWM signal to cause the current to rise, and vice versa. Conventional PI control systems can be used for current control. By comparing the reference current with the actual current value as feedback and processing it through the PI controller to calculate the duty cycle, closed-loop control can be achieved.

### Additional Engine Configuration Examples

Table 1 shows additional engine configurations that can be configured with the exemplary plasma chamber (e.g., 102, 104).

TABLE 1

| Element | Option 1 | Option 2 | Option 3 | Option 4 | Option 5 |
|---|---|---|---|---|---|
| Compressor | Electric motor | Turbine | Electric motor | Turbine | Ram air |
| | driven axial | driven axial | driven radial | driven radial | |
| | compressor | compressor | compressor | compressor | |
| Coupling | Direct | Gearbox | | | |
| Bypass air | No bypass | Low bypass | High bypass | | |
| | (turbojet) | turbofan | turbofan | | |
| Main heating | Electric arcing | Fuel | Arcing- | Parallel | Series chambers |
| | | combustion | enhanced | chambers | for el. arcing |
| | | | combustion | for el. arcing | and fuel |
| | | | | and fuel | combustion |
| | | | | combustion | |
| Nozzle | Convergent | Convergent- | Divergent | | |
| | (subsonic) | divergent | (supersonic, | | |
| | | (subsonic to | i.e. equivalent | | |
| | | supersonic) | to SCRAMJET) | | |
| Reheating | Electric arcing | Fuel | Arcing- | Series chambers | |
| (afterburner) | | combustion | enhanced | for el. arcing | |
| | | | combustion | and fuel | |
| | | | | combustion | |

Pure-Electric, No Afterburner, Turbojet, Turbine-Powered. FIG. 1A shows a pure turbojet electric configuration with no bypass air. Another option is a turbofan configuration with either low bypass or high bypass, which can depend on the application. There are several arcing chambers operating in parallel. The turbine 113 can drive the compressor 110 either directly or via a gearbox, which can depend on the application. Compressor 110 and turbine 113 can be of different types, e.g., having an axial turbine.

Pure-Electric, With Afterburner, Turbojet, Turbine-Powered. FIG. 2A shows another pure-electric, turbojet, turbine-powered configuration configured with multiple plasma chambers. The configuration is the same as in FIG. 1A, but it has an additional reheater 102a (i.e., thrust augment or, afterburner).

Conventional Turbojet, Arcing Afterburner, Turbine-Powered. FIG. 2B shows a conventional turbojet, arcing afterburner, and turbine-powered configuration. The configuration is also outfitted with an electric afterburner 124 as in FIG. 2A and, e.g., a conventional turbojet, which is powered by a combustion chamber 126.

Pure-Electric, No Afterburner, Turbojet, Motor-Powered. FIG. 2C shows a pure-electric, no afterburner, motor-powered, turbojet configuration. The configuration is pure turbojet, i.e. no bypassed air. The compressor 110 is driven by an electric motor 128 to provide higher arcing chamber exit temperatures. The configuration may employ a heavier drive mechanism.

Pure-Electric, No Afterburner, Turbojet, Motor-Powered. FIG. 2D shows a pure-electric, no afterburner, motor-powered, turbojet configuration. The configuration is the same as in FIG. 2C, but the electric motor 128 is now coupled with a gearbox 130. The gearbox 130 is also coupled with the compressor 110.

### Experimental Results and Additional Examples

A study was conducted to develop and evaluate an air-breathing plasma engine employing an arc plasma chamber that generates plasma (e.g., electrode-coupled, direct current plasma) via electrodes continuously fed by an electrode-feeding assembly. The study employed an experimental platform that would heat an airflow above 1,000 Kelvin via a 500 kW system.

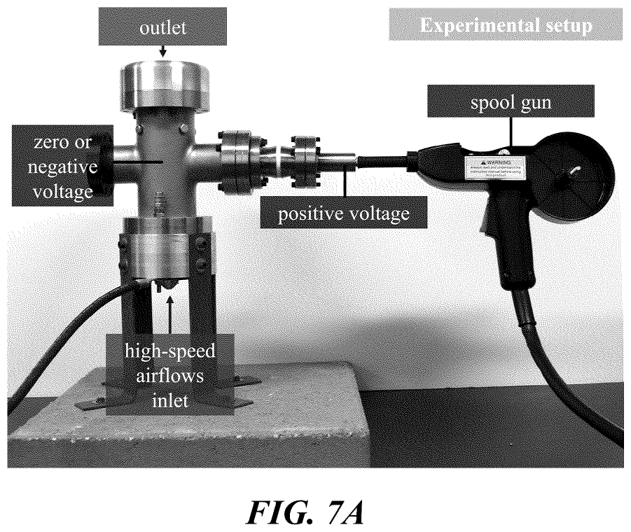

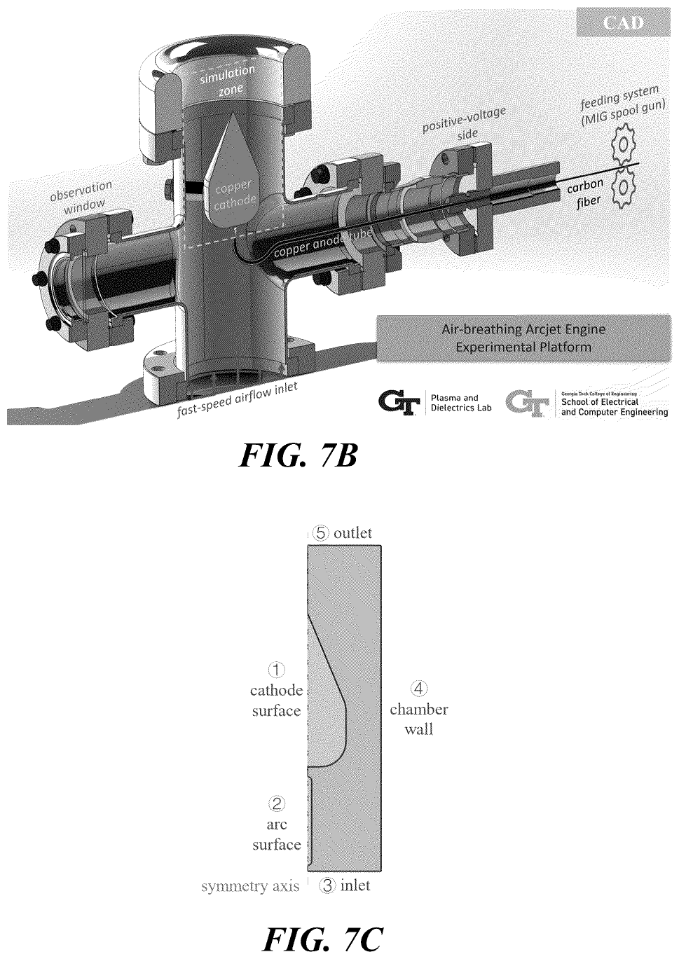

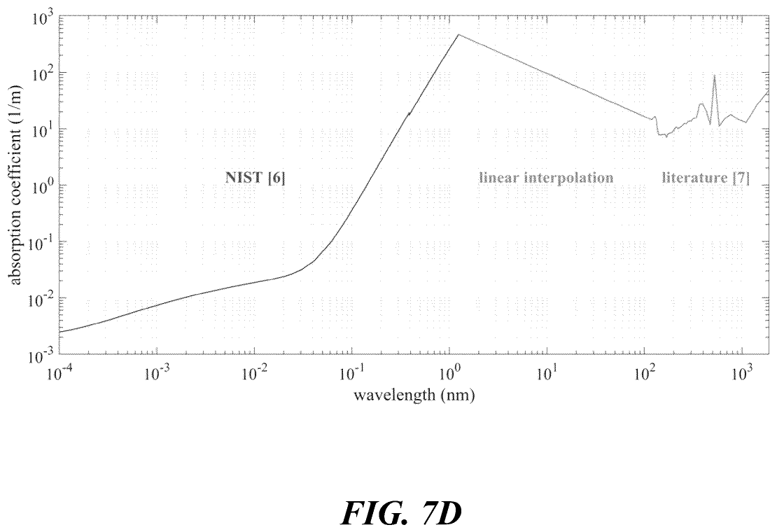

FIGS. 7A and 7B shows an experimental setup to evaluate heat transfer process in a plasma chamber according to the working principle of air-breathing arcjet engines. The arc chamber of the study is a 4-way cross ConFlat vacuum nipple. A fan was installed at the bottom to generate high-speed airflow, and the top opening that holds the drop-shaped cathode served as the outlet. The left opening was reserved for an observing window, and the right opening was connected to a ceramic vacuum break that separates the chamber (zero or negative voltage) from the positive side. This right opening also acted as a channel for carbon fiber injection. A metal inert gas (MIG) welding spool gun located on the positive side was employed to feed carbon fiber into the arc chamber. The feeding rate is a critical parameter and depends on factors such as arc current, air velocity, and temperature.

The axisymmetric model of the arc chamber was designed in COMSOL Multiphysics to calculate the steady-state solution to the heat transfer problem of high-speed airflow around the column electric arc. The geometry of the model was based on the experimental setup described in FIG. 7B. As illustrated in FIG. 7C, the model simplifies the column arc as a cylindrical entity in the middle of the arc chamber, thus avoiding solving the complex magnetohydrodynamic (MHD) problem and focusing on the computational fluid dynamics and heat transfer simulations. Notably, the arc region in the model was not in direct contact with the surface of the cathode and anode (not included in the model) to prevent discontinuities in the simulation model arising from assigning different temperatures to the arc and electrode surfaces.

Considering the high velocity and low viscosity nature of the airflow in the arc chamber of the jet engine, the airflow was expected to be in the turbulent flow regime (the Reynolds number of the 100 m/s airflow in the established arc chamber is 9440). As a result, the model employed the Reynolds-averaged Navier-Stokes equations and k-ε turbulence model to solve the turbulence flow problem. The localized heat balance equation was used to compute the temperature of high-speed airflow. Due to the very limited surface area of the column arc and the high velocity of airflow, the study expected the heat transfer from arc to airflow contributed by conduction and convection to be significantly lower than by radiation. The model also considered the radiation of the arc and the absorption, emission, and scattering of radiation by the participating medium (airflow). In COMSOL, the heat transfer by radiation in the participating media was governed by the radiative transfer equation, with the PI approximation (the simplest form of the spherical harmonics methods) used to discretize the directions.

The two critical parameters that affect the heat transfer process in the arc chamber were the absorption coefficient and the scattering coefficient, both reliant on radiation wavelength. Literature and NIST provide the absorption coefficient of air for radiation in different wavelength ranges, covering the ranges of 1983.7 nm to 116.7 nm and 1.24 nm to 12.4 fm, respectively. These coefficients were integrated into the COMSOL simulation. Given the weak absorption ability of air at longer-wavelengths, the model assumes that the absorption coefficient of air for radiation with wavelengths above 763 nm is zero. For radiation with wavelengths between 116.7 nm and 1.24 nm, linear interpolation connects the gap between the two sets of absorption coefficient data. In addition, the absorption coefficient for radiation with wavelengths below 12.4 fm was also assumed to be zero. As for the scattering coefficient, the model employed zero, i.e., disregarding the scattering of radiation during the propagation. FIG. 7D shows the resulting absorption coefficients.

Boundary and Initial Conditions. The study considered five boundaries in the model, as demonstrated in FIG. 7C. Boundaries 1, 2, and 4 were the surface of the cathode, the surface of the column arc, and the wall of arc chamber, respectively. Conditions on these boundaries were more related to the heat transfer. Boundaries 3 and 5 were the inlet and outlet of the chamber, whose conditions are more related to the fluid dynamics. All boundary conditions are summarized in Table 2.

TABLE 2

| Boundary Condition | Description |
|---|---|
| Boundary 1—cathode | Temperature: 600 K; Blackbody radiation |
| | (temperature: 600 K); No slip wall |
| Boundary 2—arc | Temperature: arc temperature (9600 K); |
| | Blackbody radiation (temperature: arc |
| | temperature); No slip wall |
| Boundary 3—inlet | Airflow inlet velocity: 100 m/s fully developed |
| | flow; Airflow inlet temperature: 293.15 K; 99% |
| | transparent surface to radiation (same for all |
| | wavelength) |
| Boundary 4—chamber | Fully reflect surface to radiation (same for all |
| wall | wavelength); Thermal insulation; No slip wall |
| Boundary 5—outlet | Airflow outlet; 99% transparent surface to |
| | radiation (same for all wavelength). The initial |
| | velocity of the airflow is 0 m/s and the initial |
| | temperature in the arc chamber is 293.15 K. |

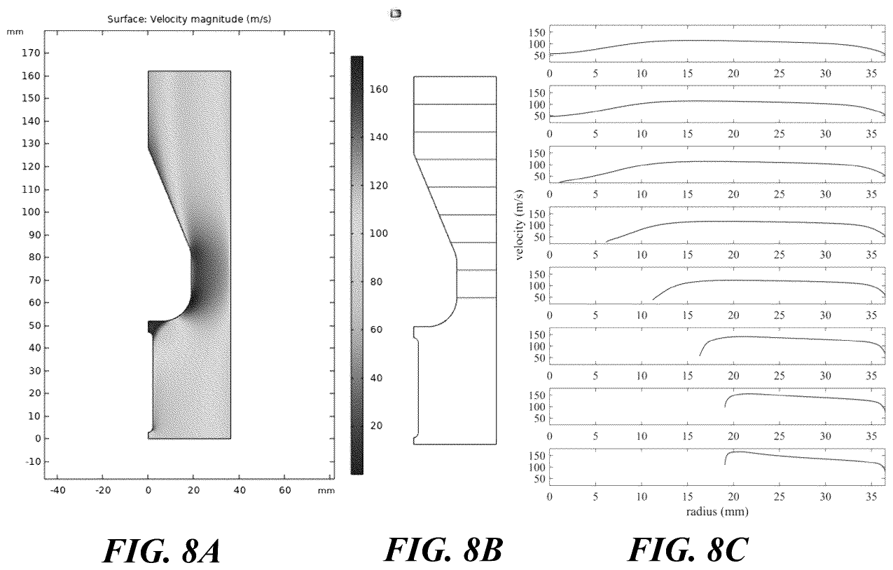

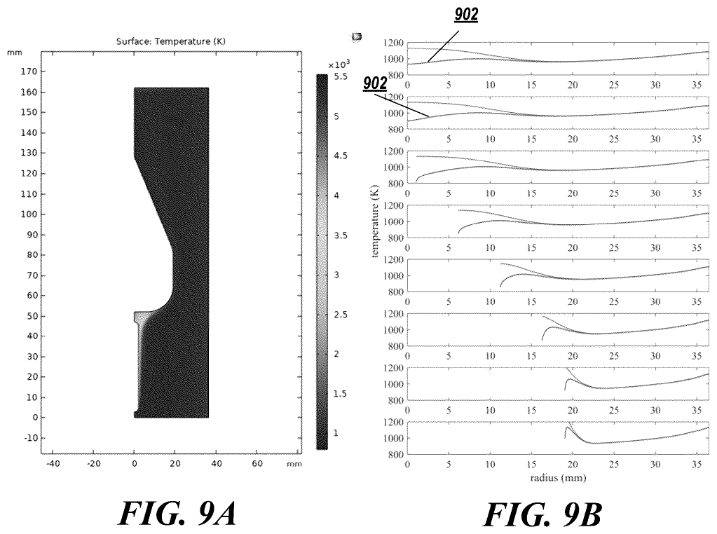

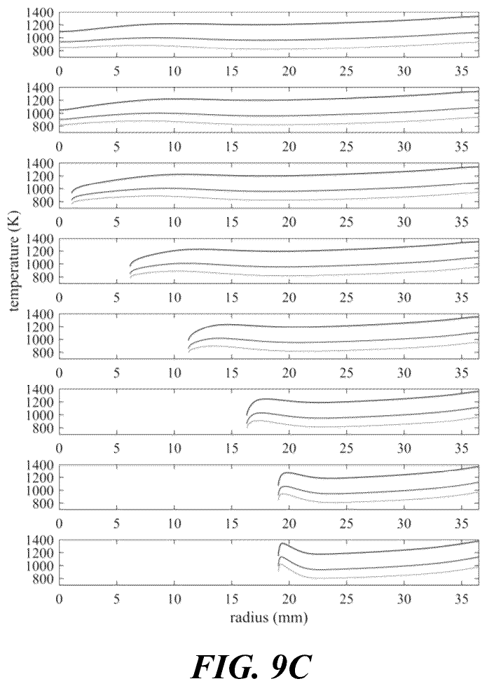

Simulation Results. FIGS. 8A-8C and 9A-9C show numerical simulation results of the heat transfer process in a plasma/arc chamber.

FIG. 8A depicts the airflow velocity distribution in the arc chamber, displaying a notable increase in velocity at the maximum radius of the cathode and then a gradual decrease along the direction toward the outlet. To present the simulation results more comprehensively, multiple cutlines have been introduced; from the maximum radius of the cathode to the outlet, as detailed in FIG. 8B. FIG. 8C plots the velocity along each cutline, revealing that the airflow velocity gradually becomes uniform as it approaches the outlet.

FIG. 9A illustrates the temperature distribution in the arc chamber. It can be observed that the temperature around the column arc is very high. However, this high-temperature area is very narrow and the temperature in most areas is relatively low and uniform. In FIG. 9B, the lines 902 represents the temperature along the cutlines. Since the airflow close to the cathode originally comes from the vicinity of the arc, the temperature near the cathode is higher. As the air flows further toward the outlet, the temperature distribution becomes more uniform and the average temperature near the outlet reaches 1018.9 K.

To further investigate the contribution of the arc and cathode to heat transfer, the boundary condition of the cathode surface is set to adiabatic (thermal insulation), and its radiation intensity is then set to 0. The temperature distribution under this setup is shown as the orange (upper) lines in FIG. 9B. It can be observed that the temperature curve does not change except in the area close to the cathode. This indicates that the arc is the major heat source in the arc chamber. The temperature close to the cathode increases because the electrode surface is now adiabatic and no longer absorbs heat from the high-temperature airflow. Moreover, different velocities (80 m/s, 100 m/s, 120 m/s) are specified at the inlet (Boundary 3) to investigate the influence of airflow velocity on the temperature distribution. The results are demonstrated in FIG. 9C, where the blue (upper), orange (middle), and yellow (lower) lines represent the temperature distribution under 80 m/s, 100 m/s, and 120 m/s airflow, respectively. The outcomes are as expected: the higher the airflow velocity, the lower the temperature near the outlet.

The total heat absorption power of the airflow is calculated using (1), where r_{\dot{m}} denotes the mass flow rate, Cₚ represents the specific heat capacity, and ΔT represents the temperature difference between the inlet (293.15 K) and outlet (average value: 1018.9 K). Although the specific heat capacity varies with temperature, the difference between Cₚ at 293.15 K and 1018.9 K is negligible. Therefore, the Cₚ at 293.15 K is leveraged for computation. Subsequently, the heat flux emitted from the column arc (Boundary 2) is extracted from the COMSOL model, which includes conductive, convective, and radiative heat flux. These parameters enable the calculation of the total heating power emitted by the electric arc.

$$P = {r}_{\dot{m}} {C}_{p} Δ \qquad ( Eq . 6 )$$

Table 3 shows the total heat absorption power of the airflow, arc-emitted power through conduction and convection, and arc-emitted power through radiation.

TABLE 3
Total Heat Absorption Power of Airflow and Emitted
Power of Electric Column Arc

| Total absorption | Emitted convective and | Emitted radiative |
|---|---|---|
| power of airflow | conductive power | power |
| 394.72 kW | 7.56 kW | 483.77 kW |

Approximately 80.3% of the power emitted by the arc was absorbed by the airflow. The non-absorbed may be explained by (i) the radiative heat flux not being able to be fully absorbed by the air because of the dependency of absorption coefficient on wavelength, (ii) loss by the cathode absorbing a certain amount of heat, and (iii) the radiation towards the inlet and outlet (Boundary 3 and 5) not being absorbed. Nevertheless, the results show that the radiation power surpasses the combined convective and conductive power by more than sixty times. This illustrates that the radiation of the arc makes the primary contribution to heating the surrounding high-speed airflow. Extrapolating from the results, it was estimated that over 500 kW of input power can be employed to sustain the arc within the high-speed airflow and the desired temperature of the airflow.

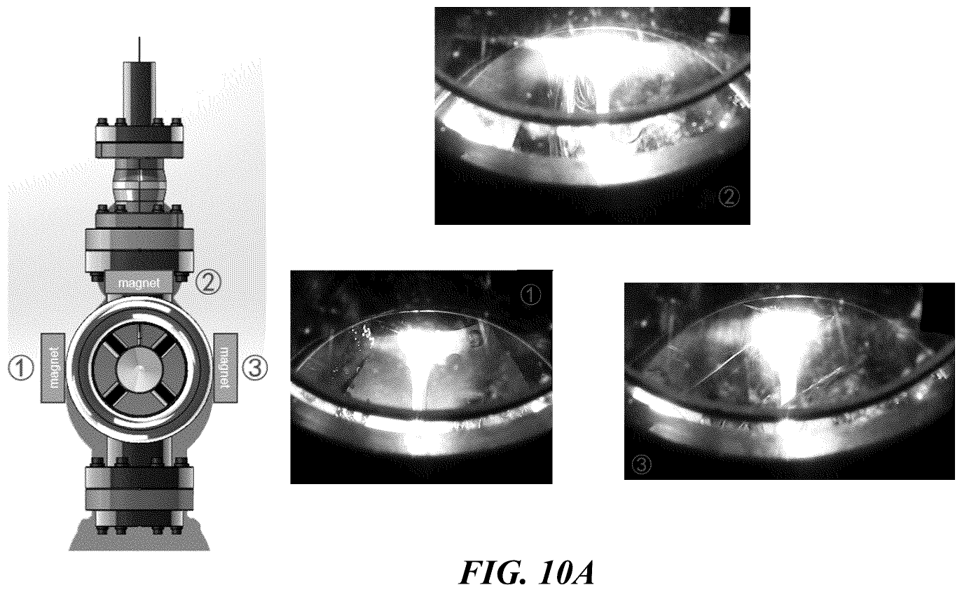

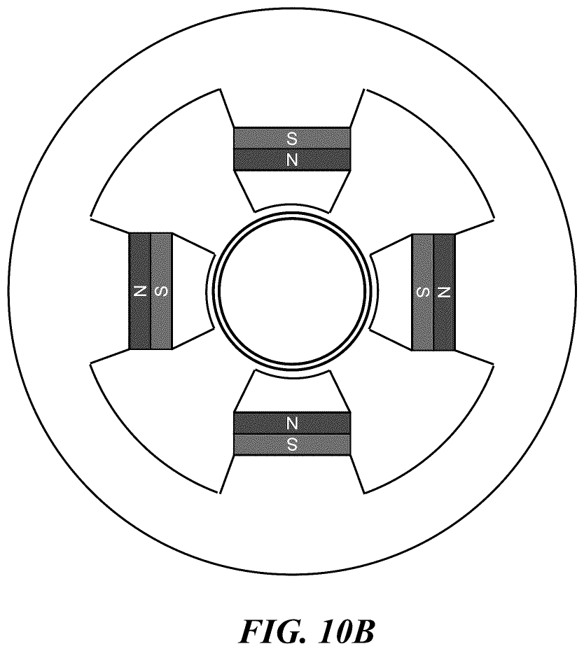

Arcing experiments. Arcing experiments are conducted in the experimental setup shown in FIG. 10A. A cascaded variac is employed to control the power from a 3-phase 120 V 30 A source. The alternative current (AC) voltage is then fed into a rectifier to generate the direct current (DC) voltage required for the experiments. By applying different DC voltages across the copper cathode and carbon fiber anode, different consumption rates of carbon fiber due to arcing experiments can be achieved. The feeding rate of carbon fiber in the experiment is adjusted so that it can compensate for the consumption rate. During the experiment, the arc current and voltage between contacts are measured, and the shape of the arc is captured using a Canon EOS 80D camera through the observation window. To attenuate the intensity of the electric arc, a 2-stop neutral density filter is used. It is important to note that the electric ducted fan is deactivated during all arcing experiments to ensure that the arc can be maintained. This is because, due to the limited input power provided by the circuit, the pinch force (Lorentz force) induced by the arc itself cannot counteract the volume force due to high-speed blowing. Instead, the outlet of the arc chamber is connected to the venting tube of the laboratory, thus creating an airflow of about 1 m/s. Moreover, compressed air is fed into the copper tube through a MIG spool gun to prevent the copper tube from melting due to the high temperature of the arc.

It can be observed in the study that a jet shape (conical shape) electric arc forms between the tip of the carbon fiber and the copper cathode. As the input power increases, the length of the arc gradually increases as well. As the input power increases, the length of the arc increases correspondingly. When the instantaneous input power reaches 12 KW, the arc directly bridges the gap between the copper tube and the copper cathode. A thermal coupler is installed between the inner wall of the chamber and the maximum radius of the copper cathode. When the instantaneous input power reaches 12 kW, the maximum temperature reading is 440.65 K.

The voltage signal from the spool gun indicated the start and stop of the feeding of carbon fibers. It can be observed that the carbon fiber feeding commences at approximately 0.4 seconds. Following this, a distinct decrease in the voltage between cathode-anode terminals and the initiation of current flow was observed. In the interval between 2 seconds to 5 seconds, the voltage stabilizes at around 80 V, and the current is maintained at around 20 A. After the feeding of carbon fiber ceases, the voltage gradually increases, and the current slowly diminishes to zero. The input power during this process is approximately 2 kW.

The investigation of the heat transfer process between the electric arc and the surrounding high-speed airflow was conducted through finite element simulation. The findings suggest that radiation is the primary mechanism for the arc to heat the surrounding high-speed airflow. It is estimated that an input power exceeding 500 kW would be required to maintain the arc within the high-speed airflow and to reach the desired airflow temperature. Furthermore, experimental results demonstrate that the proposed carbon fiber feeding mechanism can effectively initiate and sustain a DC arc. To enhance heat transfer power, it is necessary to increase the arc length, which introduces several challenges. Firstly, the substantial volume force resulting from the high-speed airflow can extinguish the arc, necessitating a suitable increase in input power (arc current) and utilization of a magnetic arc control system that can assist in stabilizing the arc. Secondly, the arc length (which depends on the feeding rate and input power) must be meticulously controlled to prevent the arc from bridging between the metal electrodes.

Example Magnetic Field Control System. The magnetic control system used to contain and guide the plasma generated in the engine (e.g., the magnetic confinement system 420 of FIG. 4) may include a variety of geometries and orientations. The shape and orientation of the magnet(s) affect the arc shape and location in the airflow. Thus, the magnet shape may be optimized for specific applications to ensure effective plasma distribution and shape.

FIG. 10A shows an example system of a plasma chamber including 3 magnets (labeled magnet 1, magnet 2, and magnet 3). Each of the three magnets was oriented around the plasma chamber, separated by 90 degrees from each other. While only three magnets are shown, in other implementations, more magnets may be used (e.g., 4 or more magnets). The orientation of the magnet poles may be flipped depending on their location (e.g., South inward vs. North inward with respect to the arc).

In particular, the arrangement of four magnets (a magnet quadrupole magnet) was investigated. The larger view of the quadrupole magnet is shown in FIG. 10B. Each of the magnets was arranged around the plasma chamber, separated by 90 degrees from each other. Opposing magnets are arranged with similar poles facing inwards. For example, the magnets on the left and right each have the south pole facing inward, while the magnets on the top and bottom of FIG. 10B each has the south pole facing outward. The resulting arrangement adequately holds the plasma arc in the plasma chamber with the desired shape.

Example Control System and Circuit. The exemplary air-breathing arc jet system can operate on low-voltage direct current sources another other power sources. A typical arc voltages are of the same order of magnitude as today's power-train battery voltages. A non-isolating DC-DC converter, such as a boost or buck converter, can be employed for fast control of arc heating. If the output is in current-control mode with a significant output inductance, the converter may stabilize the arc. Local arc temperature change due to fluid-dynamic, thermodynamic, electro-hydrodynamic, and chemical processes could be compensated by quickly adapting arc voltage with virtually no delay time due to the constant current control.

To operate the plasma generating elements, a circuit system was developed to ensure the stability of a DC arc. A fully controllable current source was implemented with a buck converter to regulate the arc current, as shown in FIG. 6A.

The input and output of a buck converter are both direct current. To provide the buck converter with a DC input, in the laboratory setting, a three-phase rectifier was used to rectify three-phase AC power, resulting in a 480V DC input for the buck converter. In real application, a battery would be utilized. The direct voltage obtained by rectifying three-phase AC power contains ripples. To reduce these ripples, a voltage regulator capacitor was employed in 480V DC link. Initially, when the AC power is first connected, the voltage across the capacitor is zero. To prevent excessive charging current when the AC power is initially connected, a charging resistor is added to limit the charging current of the capacitor. Once the capacitor charging process is complete, the breaker is closed, and the load current is supplied to the buck converter through the breaker instead of the charging resistor. In real applications, the voltage will increase.

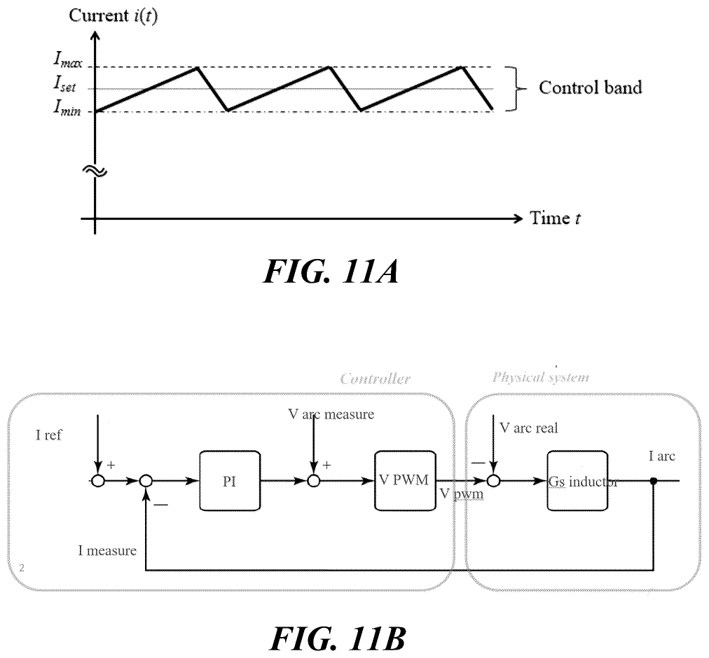

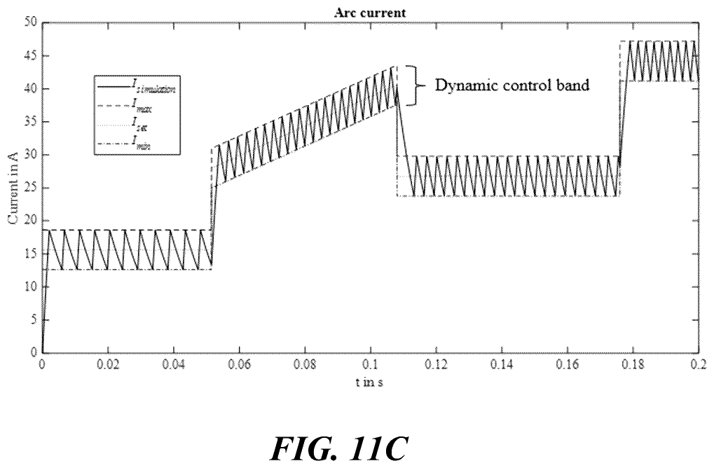

Buck Converter Control Method 1 Hysteresis Controller: The output current of the buck converter (e.g., as described in relation to FIG. 6A) can be controlled using an IGBT (Insulated Gate Bipolar Transistor), which functions as a rapidly controllable switch. When the IGBT is turned on, the switch current, as shown by the green line in the diagram in FIG. 11A, flows through the IGBT, inductor, and the arc load. Due to the energy storage property of the inductor, the current continuously rises. When the IGBT is turned off, as indicated by the black line in the left diagram, the switch current flows through the inductor, the arc load, and the diode below. Since the IGBT is off, the load loses the 480V power supply, causing the current to decrease.

FIG. 11A shows a band that can be used in the hysteresis control. When the current exceeds the top line, the IGBT is turned off to decrease the current. Conversely, when the current falls below the bottom line, the IGBT is turned on to increase the current. This ensures that the current remains stable within the band formed by the red and blue lines. By employing this method, effective control of the current can be achieved. FIG. 11C shows the Simulink simulation results wherein the inner line represents the current flowing through the arc load and inductor, fluctuating within the band formed by the upper lines and lower lines. By constructing a reasonable band, effective control of the current can be achieved.

Buck Converter Control Method 2—PI Controller: From Method 1, turning on the IGBT can cause the arc current to increase, while turning off the IGBT causes the arc current to decrease. By adjusting the proportion of time, the IGBT is turned on during its switching cycle, known as the duty cycle of the PWM signal, the study can also control the current.

A higher duty cycle increases the ability of the PWM signal to cause the current to rise, and vice versa. Thus, conventional PI control systems can be used for current control. By comparing the reference current with the actual current value as feedback and processing it through the PI controller to calculate the duty cycle, closed-loop control can be achieved, as shown in the diagram of FIG. 11B. The left half of FIG. 11B represents the PI controller, while the right half represents the control model of the actual physical system. The controller incorporates the measured arc voltage signal to compensate for voltage disturbances in the actual physical system, allowing the control system to better track the reference current.

The simulation results also shown in FIG. 11C indicate that traditional PI controllers have a constant IGBT switching frequency, making them more suitable for situations where there is significant noise in the current measurement. According to the simulation results, the arc current value can effectively track the changing Iₛₑₜ.

### CONCLUSION

Various sizes and dimensions provided herein are merely examples. Other dimensions may be employed.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

While the methods and systems have been described in connection with certain embodiments and specific examples, it is not intended that the scope be limited to the particular embodiments set forth, as the embodiments herein are intended in all respects to be illustrative rather than restrictive.

The following patents, applications and publications as listed below and throughout this document are hereby incorporated by reference in their entirety herein.

### REFERENCE LIST

[1] Albert R. G., Raymond L. S., Jayant S. S., Steven R. H. B., “Technical and Environmental Assessment of All-electric 180-Passenger Commercial Aircraft,” Progress in Aerospace Sciences, Vol. 105, February 2019, pp. 1-30. doi: 10.1016/j.paerosci.2018.11.002
[2] Andreas W. S., Steven R. H. B., Khan D., Lynnette M. D., Albert R. G., Rod S., Aidan O., et al., “Technological, Economic and Environmental Prospects of All-electric Aircraft,” Nature Energy, Vol. 4, February 2019, pp. 160-166. doi: 0.1038/s41560-018-0294-x
[3] Giampaolo B., Pat W., Dishan B., “The More-Electric Aircraft and Beyond,” Nature Energy, Vol. 111, No. 4, April 2023, pp. 356-370. doi: 10.1109/JPROC.2022.3152995
[4] Graber L., Guo N., Payman A. R., Nawaz A., “Concept for an Air-Breathing Electric Arcjet Engine,” submitted to the AIAA/IEEE Electric Aircraft Technologies Symposium, 2024.
[5] Birk W., Quang H. L., Georg H., “Overview of Thermal Arcjet Thruster Development,” Aircraft Engineering and Aerospace Technology, Vol. 90, Issue. 2, March 2018, pp. 280-301. doi: 10.1108/AEAT-08-2016-0124
[6] Meyerott R. E., Sokoloff J., Nicholls R. W., “Absorption Coefficients of Air,” Geophysical Research Papers, Vol. 68, No. 277, July 1960.
[7] Hubbell J. H., Seltzer S. M., “X-Ray Mass Attenuation Coefficients,” NIST [online database], URL: https://physics.nist.gov/PhysRefData/XrayMassCoef/ComTab/air.html [retrieved 8 Dec. 2023].
[1′] E. Gent, “MIT Unveils a Megawatt Motor for Electric Aircraft—The electrification of regional jets is now within striking distance,” IEEE Spectrum, 2023
[2′] J. Chu, “MIT engineers fly first-ever plane with no moving parts—The silent, lightweight aircraft doesn't depend on fossil fuels,” MIT News, 2018.
[3′] C. Bapst, “Mission Definition, Analysis and Operation Potential of a Hybrid-Electric Aircraft based on the Do228 Design,” Master Thesis ETH Zurich, 2017.
[4′] L. Graber, A. Payman, M. Tousi, A. West, Z. Jin, “Air-breathing plasma jet engine,” U. S. Provisional Patent 63/251,167, 2021.
[5′] N. Guo, P. M. O′malley, L. F. Valle, L. E. Pacas, A. M Finan, K. Sangar, D. Han, L. Graber, “Heat Transfer Study of an Air-Breathing Arcjet Engine Concept,” submitted to the AIAA/IEEE Electric Aircraft Technologies Symposium, 2024.
[6′] G. W. Butler, R. J. Cassady, “Directions for arcjet technology development,” Journal of Propulsion and Power, 12 (6), pp. 1026-1034, 1996. https://doi.org/10.2514/3.24140
[7′] A. Calomino, W. Bruce, P. Gage, D. Horn, M. Mastaler, D. Rigali, J. Robey, L. Voss, J. Wahlberg, C. Williams, “Evaluation of the NASA arc jet capabilities to support mission requirements,” NASA Report, No. SP-2010-577, 2010.
[8′] G. R. Jones, M. T. C. Fang, “The physics of high-power arcs,” Reports on Progress in Physics, 43 (1415), 1980.
[9′] P. Schavemaker, L. van der Sluis, “Electrical Power System Essentials,” Wiley, 2nd Ed., 2017. Page 17.
[10′] J. Johnson, W. Bower, M. Quintana, “Electrical and Thermal Finite Element Modeling of Arc Faults in Photovoltaic Bypass Diodes,” Sandia Report, SAND2012-0743, Chapter 3, 2012.
[11′] G. Herdrich, T. Binder, A. Boxberger, A. Chadwick, Y. A. Chan, M. Ehresmann, N. Harmansa, C. Montag, F. Romano, J. Skalden, S. Fasoulas, “Research and development on electric and advanced propulsion at IRS,” Proceedings of the 35th International Electric Propulsion Conference, Atlanta, GA, USA, pp. 8-12, October 2017.
[12′] L. Graber, P. O′malley, A. Payman, M. Tousi, “Electrode System and Control Mechanism for Air-Breathing Plasma Jet Engines”, U. S. Provisional Patent 63/504,353, 2023.
[13] Y. Ju, W. Sun, “Plasma Assisted Combustion: Progress, Challenges, and Opportunities,” Combustion and Flame, 162, 2015.
[14] Y. Ju, W. Sun, “Plasma Assisted Combustion: Dynamics and Chemistry,” Progress in Energy and Combustion Science, 48, 2015.

What is claimed is:

1. An engine comprising:
an inlet configured to receive input air;
a compressor stage coupled to the inlet, the compressor stage being configured to compress the input air and reduce velocity of the input air between an entry section of the compressor stage and an exit section of the compressor stage;
a plasma chamber operatively coupled to the compressor stage to receive compressed air from the compressor stage, the plasma chamber comprising a set of continuously-fed electrodes configured to generate an electric arc to convert the compressed air to an electrically conductive plasma.

2. The engine of claim 1, wherein the set of continuously-fed electrodes, as anodes, includes at least one rigid graphite rod drawn from a cassette.

3. The engine of claim 1, wherein the set of continuously-fed electrodes, as anodes, includes at least one carbon rod drawn from a spool of flexible carbon fiber cable.

4. The engine of claim 1, wherein the set of continuously-fed electrodes is configured to be consumed during operation and converted to an exhaustible gas.

5. The engine of claim 1 further comprising a cathode, the cathode being made of copper, graphite, or copper tungsten composite.

6. The engine of claim 5, wherein the cathode is configured to produce a transverse magnetic field to force an electric arc generated in an airflow stream of the compressed air to rotate.

7. The engine of claim 1, further comprising:
a nozzle stage coupled to the plasma chamber, the nozzle stage being configured to expand the electrically conductive plasma and heated air to generate an impulse.

8. The engine of claim 1, further comprising:
a combustion chamber operatively coupled to the compressor stage to receive compressed air from the compressor stage, the combustion chamber comprising a fuel injection nozzle configured to inject and ignite a fuel within the combustion chamber, wherein the plasma chamber is coupled to the combustion chamber to heat a combustion mixture with the electrically conductive plasma and heated air.

9. The engine of claim 1, wherein the plasma chamber includes fuel injector configured to inject fuel into the plasma chamber to cause combustion, the continuously-fed electrodes causing the plasma chamber to heat a combustion mixture with the electrically conductive plasma and heated air.

10. The engine of claim 5, further comprising a magnetic confinement device adjacent to the plasma chamber and configured to generate a magnetic field to contain a placement and/or shape of the electric arc generated between the set of continuously-fed electrodes, as an anode, and the cathode.

11. The engine of claim 1, further comprising a drive roller configured to drive the set of continuously-fed electrodes into the plasma chamber.

12. The engine of claim 11 further comprising a controller operatively coupled to the drive roller, the controller being configured to adjust the drive roller operation based on one or more of (i) measured arc voltages, (ii) arc current, or (iii) airflow speed.

13. An electrode feeding system comprising:
a set of continuously-fed electrodes configured to be consumed and converted to an exhaustible gas;
a drive roller configured to drive the set of continuously-fed electrodes into a plasma chamber; and
a controller operatively coupled to the drive roller, the controller being configured to adjust the drive roller operation based on one or more of (i) a measured arc voltage, (ii) arc current, or (ii) airflow speed, in the plasma chamber.

14. The electrode feeding system of claim 13 further comprising:
a cathode, the cathode being made of copper or copper metal matrix composite and configured to produce a transverse magnetic field to force an electric arc generated in an airflow stream of the compressed air to rotate.

15. The electrode feeding system of claim 13, wherein the set of continuously-fed electrodes, as anodes, includes one of (i) at least one rigid graphite rod drawn from a cassette or (ii) at least one carbon rod drawn from a spool of flexible carbon fiber cable.

16. A method comprising:
receiving, in an engine, input air;
compressing, at a first stage of the engine, the input air and reducing input air velocity to generate compressed air;
converting the compressed air to an electrically conductive plasma at a second stage of the engine configured to generate an electric arc in an airflow stream of the compressed air, wherein the electric arc is generated with a set of continuously-fed electrodes; and
expanding the electrically conductive plasma to generate an impulse of the engine, wherein the heat introduced at the first stage of the engine is combined with heat generated at the second stage to contribute to the impulse generation.

17. The method of claim 16, wherein the second stage of the engine further comprises:
injecting a fuel into a combustion stage; and
igniting the fuel in the combustion stage to generate an impulse of the engine.

18. The method of claim 17, wherein a ratio of the impulse generated by the conductive plasma to the impulse generated by the combustion stage is continuously adjustable.

19. The method of claim 16, further comprising:
converting the compressed air to an electrically conductive plasma at a third stage of the engine adjacent to a nozzle.

20. The method of claim 16, further comprising:
feeding the set of continuously-fed electrodes, as anodes, from a spool of flexible carbon fiber cable, wherein the flexible carbon fiber cable is consumed during operation and converted to an exhaustible gas.
